(19) United States
(12) Patent Application Publication
(10) Pub. No.: US 2023/0296906 A1
(43) Pub. Date: Sep. 21, 2023

(54) SYSTEMS AND METHODS FOR DYNAMIC IMAGE PROCESSING

(71) Applicant: HES IP HOLDINGS, LLC, Austin, TX (US)

(72) Inventors: Yung-Chin HSIAO, Taipei City (TW); Ming Hsun HSU, Taipei City (TW)

(73) Assignee: HES IP HOLDINGS, LLC, Austin, TX (US)

(21) Appl. No.: 18/017,657

(22) PCT Filed: Sep. 30, 2021
(86) PCT No.: PCT/US2021/053048

§ 371 Date: Jan. 23, 2023

Related U.S. Application Data
(60) Provisional application No. 63/085,161, filed on Sep. 30, 2020.

(51) Int. Cl. G02B 27/02; H04N 13/344

(52) U.S. Cl. CPC G02B 27/026; H04N 13/344

(57) ABSTRACT

The present disclosure relates to system for dynamic image processing to improve a viewer's interaction with the real world by applying a virtual image display technology. The system for dynamic image processing comprises a target detection module configured to determine a target object for a viewer; an image capture module configured to take a target image of the target object; a process module to receive the target image, process the target image based on a predetermined process mode, and provide information of a virtual image related to the target image to a display module; and the display module configured to display the virtual image by respectively projecting multiple right light signals to a viewer's first eye and corresponding multiple left light signals to a viewer's second eye.

### BACKGROUND OF THE INVENTION

### Related Application

This application claims the benefit of the provisional application 63/085,161, filed on Sep. 30, 2020, titled “DYNAMIC IMAGE PROCESSING SYSTEMS AND METHODS FOR AUGMENTED REALITY DEVICES”, which are incorporated herein by reference at their entireties.

In addition, the PCT international application PCT/US20/59317, filed on Nov. 6, 2020, titled “SYSTEM AND METHOD FOR DISPLAYING AN OBJECT WITH DEPTHS” and the PCT international application PCT/US21/46078, filed on Aug. 18, 2021, titled “SYSTEMS AND METHODS FOR SUPERIMPOSING VIRTUAL IMAGE ON REAL-TIME IMAGE” are incorporated herein by reference at their entireties.

### Field of the Invention

The present disclosure relates generally to methods and systems for dynamive image processing and, in particular, to methods and systems for determining a target object, taking a target image of the target object, and displaying a virtual image related to the target object for a viewer.

### DESCRIPTION OF RELATED ART

People having vision impairment or handicap oftentimes need to carry vision aids to enhance their daily life convenience. Vision aids may typically include lenses or compound lens devices such as magnify glasses or binoculars. In recent years, portable video cameras or mobile devices have also been used as vision aids. However, these devices of the current art usually have many shortcomings. For example, magnify glasses or binoculars have very limited fields of view; portable video cameras or mobile devices may be too complicated to be operated. Additionally, these vision aids may be too cumbersome to be carried around for a prolonged period of time. Furthermore, these vision aids are not practical for the user to view moving targets, such as the bus number on a moving bus. In another aspect, people having vision impairment or handicap are more vulnerable to environmental hazards while traveling. These environmental hazards may cause slips, trips, and falls, such as a gap, unevenness, or sudden change in height occurring on the road, or cause collisions by objects, such as fast-moving vehicles or glass doors. None of the vision aids in the current art has the capability to alert people having vision impairment or handicap about these environmental hazards. To resolve these issues, the present invention aims to provide solutions to these drawbacks of the current arts.

### SUMMARY

The present disclosure relates to systems and methods to improve a viewer's interaction with the real world by applying a virtual image display technology. In details, such systems and methods determine a target object, take a target image of the target object, process the target image for a virtual image, and then display the virtual image at a predetermined size, color, contrast, brightness, location and/or depth for the viewer. As a result, the viewer, possibly with impaired vision, may clearly comprehend and interact with the real world with comfort, such as reading texts/languages, identifying persons and objects, locating persons and objects, tracking a moving objects, walking up and down stairs, moving without collision with persons and objects etc. The target object and the virtual image may respectively be two dimensional or three dimensional.

In one embodiment of the present invention, a system for dynamic image processing comprises a target detection module, an image capture module, a process module, and a display module. The target detection module is configured to determine a target object for a viewer. The image capture module is configured to take a target image of the target object. The process module receives the target image, processes the target image based on a predetermined process mode, and provides information of a virtual image related to the target image to a display module. And the display module is configured to display the virtual image by respectively projecting multiple right light signals to a viewer's first eye and corresponding multiple left light signals to a viewer's second eye. In addition, a first right light signal and a corresponding first left light signal are perceived by the viewer to display a first virtual binocular pixel of the virtual image with a first depth that is related to a first angle between the first right light signal and the corresponding first left light signal projected into the viewer's eyes.

The target detection module may have multiple detection modes. In first embodiment, the target detection module may include an eye tracking unit to track eyes of the viewer to determine a target object. In second embodiment, the target detection module may include a gesture recognition unit to recognize a gesture of the viewer to determine a target object. In third embodiment, the target detection module may include a voice recognition unit to recognize a voice of the viewer to determine a target object. In fourth embodiment, the target detection module may automatically determine a target object by executing predetermined algorithms.

The image capture module may be a camera to take a target image of the target object for further image processing. The image capture module may include an object recognition unit to recognize the target object, such as a mobile phone, a wallet, an outlet, and a bus. The object recognition unit may also perform OCR (optical character recognition) function to identify the letters and words on the target object. The image capture module may also be used to scan surroundings to identify and locate the target object by employing the object recognition unit.

The process module may apply various different manners to process the target image based on a predetermined operation mode of the system, in order to generate information of the virtual image for a display module.

The display module may comprise a right light signal generator, a right combiner, a left light signal generator, and a left combiner. The right light signal generator generates multiple right light signals which are redirected by a right combiner to project into the viewer's first eye to form a right image. The left light signal generator generates multiple left light signals which are redirected by a left combiner to project into the viewer's second eye to form a left image. In some embodiments, the system may further comprise a depth sensing module, a position module, a feedback module, and/or an interface module. The depth sensing module may measure the distance between an object in surroundings, including the target object, and the viewer. The position module may determine the position and direction of the viewer indoors and outdoors. The feedback module provides feedbacks to the viewer if a predetermined condition is satisfied. The interface module allows the viewer to control various functions of the system.

The present invention may include several system operation modes related to image processing, including a reading mode, a finding mode, a tracking mode, a collision-free mode, a walking guidance mode. In the reading mode, after receiving the target image from the image capture module, the process module may separate the texts/languages in the target object from other information, use OCR function to recognize the letters and words in the texts/languages. In addition, the process module may separate marks, signs, drawings, charts, sketches, logos from background information for the viewer. Depending on each viewer's vision characteristics, resulting from the physical features of the viewer's eyes, measured during the calibration stage, the viewer's display preferences are set up and the process module accordingly magnifies the size, adopts certain colors for these two types of information, adjusts the contrast and brightness to an appropriate level, decide the location and depth for the virtual image to be displayed.

In the finding mode, the process module may separate geometric features of the target object from the target image, such as points, lines, edges, curves, corners, contours, and/or surfaces from other information. Then, based on the viewer's display references, the process module processes the virtual image to be displayed to have a color, contrast, and brightness that can easily catch the viewer's attention.

In the tracking mode, after determining the target object by the target detection module, such as a bus, the image capture module scans surroundings to identify and locate the target object. The process module processes the target image to generate information for the virtual image based on specific applications. Once the target object is located, the virtual image is displayed usually to superimpose on the target object and then remain on the target object when it is moving.

In the collision-free mode, the system continuously scans surroundings, recognize the objects in surroundings, detect how fast these objects move towards the viewer, and identify a potential collision object which may collide into the viewer within a predetermined time period. The process module may generate information for the virtual image. Then the display module displays the virtual image to warn the viewer about the potential collision.

In the walking guidance mode, the system continuously scans surroundings, in particular the pathway in front of the viewer, recognize the objects in surroundings, detect the ground level of the area in front of the viewer who expects to walk into in a predetermined time period and identify an object which may cause slips, trips, or falls. The process module may process the target image to obtain the surface of the target object for generating information of the virtual image. The display module then displays the virtual image to superimpose on the target object such as stairs.

In some embodiments, the system further includes a support structure that is wearable on a head of the viewer. The target detection module, the image capture module, the process module, and the display module, may be carried by the support structure. In one embodiment, the system is a head wearable device, such as a virtual reality (VR) goggle and a pair of augmented reality (AR)/mixed reality (MR) glasses.

### BRIEF DESCRIPTION OF THE DRAWINGS

FIG. 1 is a block diagram illustrating an embodiment of a system with various modules in accordance with the present invention.

FIG. 2 is a schematic diagram illustrating an embodiment of a system for dynamic image processing as a head wearable device in accordance with the present invention.

FIGS. 3A-3D are schematic diagrams illustrating an embodiment of using a system for dynamic image processing to read a document in accordance with present invention.

FIGS. 4A-4B are schematic diagrams illustrating an embodiment of using a system for dynamic image processing to read a title of a book on shelves in accordance with the present invention.

FIGS. 5A-5B are schematic diagrams illustrating an embodiment of using a system for dynamic image processing to read a label on a bottle in accordance with the present invention.

FIG. 6 is a schematic diagram illustrating an embodiment of using a system for dynamic image processing to read a hand-written formula on a board in accordance with the present invention.

FIGS. 7A-7B are schematic diagrams illustrating an embodiment of using a system for dynamic image processing to read a remote sign of a store on a street in accordance with the present invention.

FIGS. 8A-8B are schematic diagrams illustrating an embodiment of using a system for dynamic image processing to find a mobile phone on a desk in accordance with the present invention.

FIG. 9A-9B are schematic diagrams illustrating an embodiment of using a system for dynamic image processing to find an electric outlet on a wall in accordance with the present invention.

FIG. 10 is a schematic diagram illustrating an embodiment of using a system for dynamic image processing to find stores on a street in accordance with the present invention.

FIG. 11 is a schematic diagram illustrating an embodiment of using a system for dynamic image processing to track a bus and a relationship between a virtual binocular pixel and the corresponding pair of the right image pixel and left image pixel in accordance with the present invention.

FIGS. 12A-12B are schematic diagrams illustrating an embodiment of using a system for dynamic image processing to avoid collision track a bus in accordance with the present invention.

FIGS. 13A-13B are schematic diagrams illustrating an embodiment of using a system for dynamic image processing guide walking upstairs and downstairs in accordance with the present invention.

FIG. 14 is a flow chart illustrating an embodiment of processes for tracking a target object in accordance with the present invention.

FIG. 15 is a flow chart illustrating an embodiment of processes for scanning surroundings to avoid in accordance with the present invention.

FIG. 16 is a schematic diagram illustrating the light path from a light signal generator to a combiner, and to a retina of a viewer in accordance with the present invention.

FIG. 17 is a schematic diagram illustrating the virtual binocular pixels formed by right light signals and left light signals in accordance with the present invention.

FIG. 18 is a table illustrating an embodiment of a look up table in accordance with the present invention.

### DETAILED DESCRIPTION OF PREFERRED EMBODIMENTS

The terminology used in the description presented below is intended to be interpreted in its broadest reasonable manner, even though it is used in conjunction with a detailed description of certain specific embodiments of the technology. Certain terms may even be emphasized below; however, any terminology intended to be interpreted in any restricted manner will be specifically defined as such in this Detailed Description section.

The present disclosure relates to systems and methods to improve a viewer's interaction with the real world by applying a virtual image display technology. In details, such systems and methods determine a target object, take a target image of the target object, process the target image for a virtual image, and then display the virtual image at a predetermined size, color, contrast, location and/or depth for the viewer. As a result, the viewer, possible with impaired vision, may clearly comprehend and the interact with the real world with comfort, such as reading texts/languages, identifying persons and objects, locating persons and objects, walking up and down stairs, moving without collision with persons and objects etc. The target object and the virtual image may respectively be two dimensional or three dimensional.

In general, the virtual image is related to the target image. More specifically, the first type of virtual image may include texts/languages, hand written or printed, on the target object, which are taken by the target image and then recognized. This type of virtual image is usually displayed at a larger font size and higher contrast for the viewer to read and comprehend the contents in the texts/languages. The second type of virtual image may include geometric features of the target object, which are taken by the target image and then recognized, including points, lines, edges, curves, corners, contours, or surfaces. This type of virtual image is usually displayed at a bright and complimentary color to highlight the shape and/or location of the target object. In addition to the texts/languages on the target object or geometric features of the target object, the virtual image may include additional information obtained from other resources such as libraries, electronic databases, transportation control center, webpages via internet or telecommunication connection, or other components of the system, such as a distance from the target object to the viewer provided by a depth sensing module. Moreover, the virtual image may include various signs to relate the above information and the target object for example with respect to their locations.

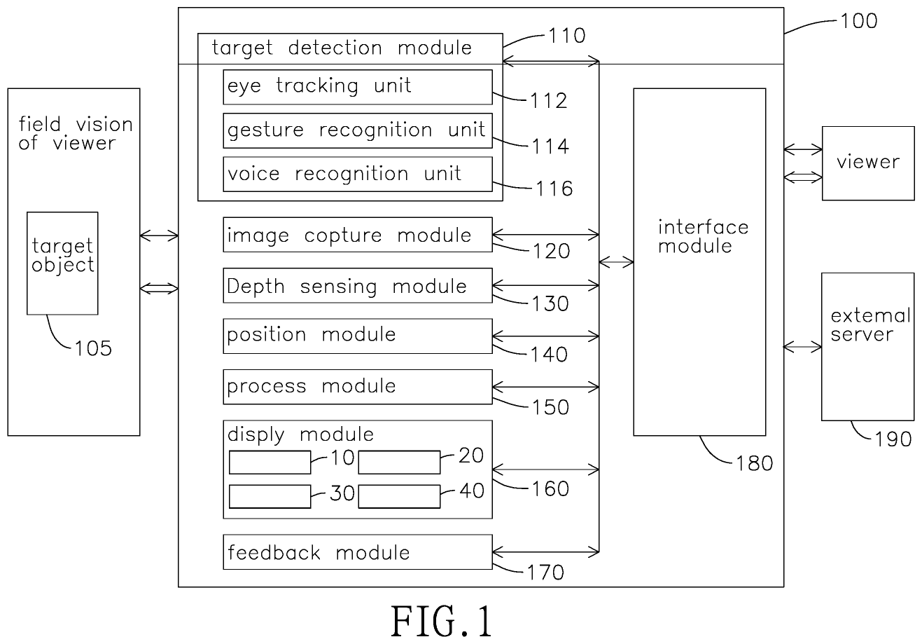

As shown in FIG. 1, a system 100 for dynamic image processing comprises a target detection module 110 configured to determine a target object for a viewer, an image capture module 120 configured to take a target image of the target object, a process module 150 to receive the target image, process the target image based on a predetermined process mode, and provide information of a virtual image related to the target image to a display module 160, and the display module 160 configured to display the virtual image by respectively projecting multiple right light signals to a viewer's first eye and corresponding multiple left light signals to a viewer's second eye. In addition, a first right light signal and a corresponding first left light signal are perceived by the viewer to display a first virtual binocular pixel of the virtual image with a first depth that is related to a first angle between the first right light signal and the corresponding first left light signal projected into the viewer's eyes.

The target detection module 110 may have multiple detection modes. In first embodiment, the target detection module 110 may include an eye tracking unit 112 to track eyes of the viewer to determine a target object. For example, the target detection module 110 uses the eye tracking module 112 to detect the fixation location and depth of the viewer's eyes, and then determines the object disposed at the fixation location and depth to be the target object. In second embodiment, the target detection module 110 may include a gesture recognition unit 114 to recognize a gesture of the viewer to determine a target object. For example, the target detection module 110 uses the gesture recognition unit 114 to detect the direction and then the object to which the viewer's index finger points, and then determines the object pointed by the viewer's index finger to be the target object. In third embodiment, the target detection module 110 may include a voice recognition unit 116 to recognize a voice of the viewer to determine a target object. For example, the target detection module 110 uses the voice recognition unit 116 to recognize the meaning of the viewer's voice, and then determines the object to which the voice is referred to be the target object. In fourth embodiment, the target detection module 110 may automatically (without any viewer's action) determine a target object by executing predetermined algorithms. For example, the target detection module 110 uses a camera or a lidar (light detection and ranging) to continuously scan surroundings, detect how fast the objects move towards the viewer, identify a potential collision object which may collide into the viewer within a predetermined time period, and then determine the potential collision object to be the target object.

The image capture module 120 may be a camera to take a target image of the target object for further image processing. The image capture module 120 may include an object recognition unit 122 to recognize the target object, such as a mobile phone, a wallet, an outlet, and a bus. The object recognition unit 112 may also perform OCR (optical character recognition) function to identify the letters and words on the target object. The image capture module 120 may also be used to scan surroundings to identify and locate the target object by employing the object recognition unit 122.

The process module 150 may include processors, such as CPU, GPU, AI (artificial intelligence) processors, and memories, such as SRAM, DRAM and flash memories. The process module 150 may apply various different manners to process the target image based on a predetermined operation mode of the system 100, in order to generate information of the virtual image for a display module 160. In addition, the image module may use the following methods to improve the quality of the virtual image: (1) sampling and quantization to digitize supplementary image; and the quantization level determines the number of grey (or R, G, B separated) levels in the digitized virtual image, (2) histogram analysis and/or histogram equalization to effectively spread out the most frequent intensity values, i.e. stretching out the intensity range of the virtual image, and (3) Gamma correction or contrast selection to adjust the virtual image.

The display module 160 is configured to display the virtual image by respectively projecting multiple right light signals to a viewer's first eye and corresponding multiple left light signals to a viewer's second eye. In addition, a first right light signal and a corresponding first left light signal are perceived by the viewer to display a first virtual binocular pixel of the virtual image with a first depth that is related to a first angle between the first right light signal and the corresponding first left light signal projected into the viewer's eyes. The display module 160 includes a right light signal generator 10, a right combiner 20, a left light signal generator 30, and a left combiner 40. The right light signal generator 10 generates multiple right light signals which are redirected by a right combiner 20 to project into the viewer's first eye to form a right image. The left light signal generator 30 generates multiple left light signals which are redirected by a left combiner 40 to project into the viewer's second eye to form a left image.

The system 100 may further comprise a depth sensing module 130. The depth sensing module 130 may measure the distance between an object in surroundings, including the target object, and the viewer. The depth sensing module 130 may be a depth sensing camera, a lidar, or other ToF (time of flight) sensors. Other devices, such as structured light module, ultrasonic module or IR module, may also function as a depth sensing module used to detect depths of objects in surroundings. The depth sensing module may detect the depths of the viewer's gesture to provide such information to the gesture recognition unit to facilitate the recognition of the viewer's gesture. The depth sensing module 130 alone or together with a camera may be able to create a depth map of surroundings. Such a depth map may be used for tracking the movement of the target objects, hands, and pen-like stylus and further for detecting whether a viewer's hand touches a specific object or surface.

The system 100 may further comprise a position module 140 which may determine the position and direction of the viewer indoors and outdoors. The position module 140 may be implemented by the following components and technologies: GPS, gyroscope, accelerometers, mobile phone network, WiFi, ultra-wideband (UWB), Bluetooth, other wireless networks, beacons for indoor and outdoor positioning. The position module 140 may include an integrated inertial measurement unit (IMU), an electronic device that measures and reports a body's specific force, angular rate, and sometimes the orientation of the body, using a combination of accelerometers, gyroscopes, and sometimes magnetometers. A viewer using the system 100 comprising a position module 140 may share his/her position information with other viewers via various wired and/or wireless communication manners. This function may facilitate a viewer to locate another viewer remotely. The system may also use the viewer's location from the position module 140 to retrieve information about surroundings of the location, such as maps and nearby stores, restaurants, gas stations, banks, churches etc.

The system 100 may further comprise a feedback module 170. The feedback module 170 provides feedbacks, such as sounds and vibrations, to the viewer if a predetermined condition is satisfied. The feedback module 160 may include a speaker to provide sounds, such as sirens to warn the viewer so that he/she can take actions to avoid collision or prevent falls, and/or a vibration generator to provide various types of vibrations. These types of feedback may be set up in by the viewer through an interface module 180.

The system 100 may further comprise an interface module 180 which allows the viewer to control various functions of the system 100. The interface module 180 may be operated by voices, hand gestures, finger/foot movements and in the form of a pedal, a keyboard, a mouse, a knob, a switch, a stylus, a button, a stick, a touch screen, etc.

All components in the system may be used exclusively by a module or shared by two or more modules to perform the required functions. In addition, two or more modules described in this specification may be implemented one physical module. One module described in this specification may be implemented by two or more separate modules. An external server 190 is not part of the system 100 but can provide extra computation power for more complicated calculations. Each of these modules described above and the external server 190 may communicate with one another via wired or wireless manner. The wireless manner may include WiFi, bluetooth, near field communication (NFC), internet, telecommunication, radio frequency (RF), etc.

The present invention may include several system operation modes related to image processing, including a reading mode, a finding mode, a tracking mode, a collision-free mode, a walking guidance mode. The first operation mode may be a reading mode for the viewer. In the reading mode, after receiving the target image from the image capture module 120, the process module 150 may separate the texts/languages (first information type in the reading mode) in the target object from other information, use OCR function to recognize the letters and words in the texts/languages. In addition to texts and languages, the process module 150 may separate marks, signs, drawings, charts, sketches, logos (second information type in the reading mode) from background information for the viewer. Then, depending on each viewer's vision characteristics, resulting from the physical features of the viewer's eyes, measured during the calibration stage, the viewer's display preferences are set up and the process module 150 accordingly magnifies the size, adopts certain color for these two types of information, including texts/language, marks etc., adjusts the contrast to an appropriate level, decide the location and depth for the virtual image to be displayed. For example, the virtual image may need to be displayed at a visual acuity equivalent to 0.5 for one viewer but 0.8 for another viewer. The size corresponding to visual acuity equivalent to 0.5 is larger than that of 0.8. Thus, when the size corresponding to visual acuity equivalent to 0.5 is used, less amount of information, such as words, may be displayed within the same area or space. Similarly, one viewer's eyes may be more sensitive to green lights but the other viewer's eyes may be more sensitive to red lights. During the calibration, the system may set up preferences of size, color, contrast, brightness, location, and depth for each individual viewer to customize the virtual image display. Such an optimal display parameters may reduce visual fatigue and improve visibility for the viewer. To facilitate the viewer's reading of these two types of information, the size, color, contrast, location, and/or depth may be further left depending on the color and light intensity of the surrounding environment. For example, when the light intensity of the surrounding environment is low, the virtual image needs to be displayed with higher light intensity or higher contrast. In addition, the virtual image needs to be displayed in a color complementary to the color of the surrounding environment.

For reading an article or a book, the virtual image with magnified font size and appropriate color/contrast may be displayed at a location adjacent to (close but not overlapped with) the target object and at approximately the same depth as the target object. As a result, the viewer can easily read the texts/languages in the virtual image without shifting the depth back and forth. For reading a sign or mark remote away, the virtual image may be displayed at a depth closer to the viewer plus an estimated distance between the viewer and the target object, for example 50 meters.

The second operation mode may be a finding mode for the viewer. In one scenario, the viewer may want to find his/her car key, mobile phone or wallet. In another scenario, the viewer may want to find switches (such as light switches) or outlets (such as electric outlets). In the finding mode, the process module 150 may separate geometric features of the target object, such as points, lines, edges, curves, corners, contours, and/or surfaces from other information. The process module 150 may use several known algorithms, such as corner detection, curve fitting, edge detection, global structure extraction, feature histograms, line detection, connected-component labeling, image texture, motion estimation, to extract these geometric features. Then, based on the viewer's display references, the process module 150 processes the virtual image to be displayed to have a color, contrast, and brightness that can easily catch the viewer's attention. In one embodiment, the virtual image may include complimentary colors, such as red and green, which flash alternatively and repeatedly. To facilitate the viewer to find/locate the target object, such virtual image is usually displayed to superimpose on the target object and at approximately the same depth as the target object. In addition to the geometric features of the target object, the process module 150 may further include marks or signs, such as an arrow, from the location where the viewer's eyes fixate to the location where the target object is located, to guide the viewer's eyes to recognize the target object. Again, the color, contrast, and brightness may be further left depending on the color and light intensity of the surrounding environment.

The third operation mode may be a tracking mode for the viewer. In one scenario, the viewer wants to take a transportation vehicle, such as a bus, and needs to track the movement of the transportation vehicle until it stops for passengers. In another scenario, the viewer has to keep his/her eye sight on a moving object, such as a running dog or cat, or a flying drone or kite. The process module 150 processes the target image to generate information for the virtual image based on specific applications. For example, for tracking a bus, the virtual image may be the bus number, including Arabic numbers and alphabets, with a circle outside the bus number. For tracking a running dog, the virtual image maybe the contour of the dog. In the tracking mode, the virtual image usually needs to be displayed to superimpose on the target object and at approximately the same depth as the target object so that the viewer may easily locate the target object. In addition, to track a target object that is moving, the virtual image has to remain superimposed on the target object when it is moving. Thus, based on the target image continuously taken by the image capture module 120, the process module 150 has to calculate the next location and depth the virtual image to be displayed and even predict the moving path of the target object, if possible. Such information for displaying a moving virtual image is then provided to the display module 160.

The fourth operation mode may be a collision-free mode. The viewer may want to avoid colliding into a car, a scooter, a bike, a person, or a glass door regardless whether he or she is moving or remain still. In the collision-free mode, the process module 150 may provide calculation power to support the target detection module 110 which uses a camera or a lidar (light detection and ranging) to continuously scan surroundings, recognize the objects in surroundings, detect how fast these objects move towards the viewer, and identify a potential collision object which may collide into the viewer within a predetermined time period, for example 30 seconds. Once a potential collision object is determined to be the target object, the process module 150 may process the target image to obtain the contour of the target object for generating information of the virtual image. To alert the viewer to take actions immediately trying to avoid a collision accident, the virtual image has to catch the viewer's attention right away. For that purpose, the virtual image may include complimentary colors, such as red and green, which flash alternatively and repeatedly. Similar to the tracking mode, the virtual image may be displayed to superimpose on the target object and at approximately the same depth as the target object. In addition, the virtual image usually has to remain superimposed on the target object which moves fast towards the viewer.

The fifth operation mode may be a walking guidance mode. The viewer may want to prevent slips, trips, and falls when he/she walks. In one scenario, when the viewer walks up or down stairs, he or she does not want to miss his/her step or take an infirm step that cause a fall. In another scenario, the viewer may want to be aware of an uneven ground (such as the step connecting a road and sidewalk), a hole, an obstacle (such as a brick or rock) before he or she walks close to it. In the walking guidance mode, the target detection module 110 which may use a camera (image capture module 120 or a separate camera) or a lidar (light detection and ranging) to continuously scan surroundings, in particular the pathway in front of the viewer, recognize the objects in surroundings, detect the ground level of the area in front of the viewer who expects to walk into in a predetermined time period, for example 5 seconds, and identify an object, for example having a height difference of more than 10 cm, which may cause slips, trips, or falls. The process module 150 may provide computation power to support the target detection module 110 to identify such an object. Once such an object is determined to be the target object, the process module 150 may process the target image to obtain the surface of the target object for generating information of the virtual image. To alert the viewer to take actions immediately trying to avoid slips, trips, and falls, the virtual image may further include an eye-catching sign displayed at the location the viewer's eyes fixate at that moment.

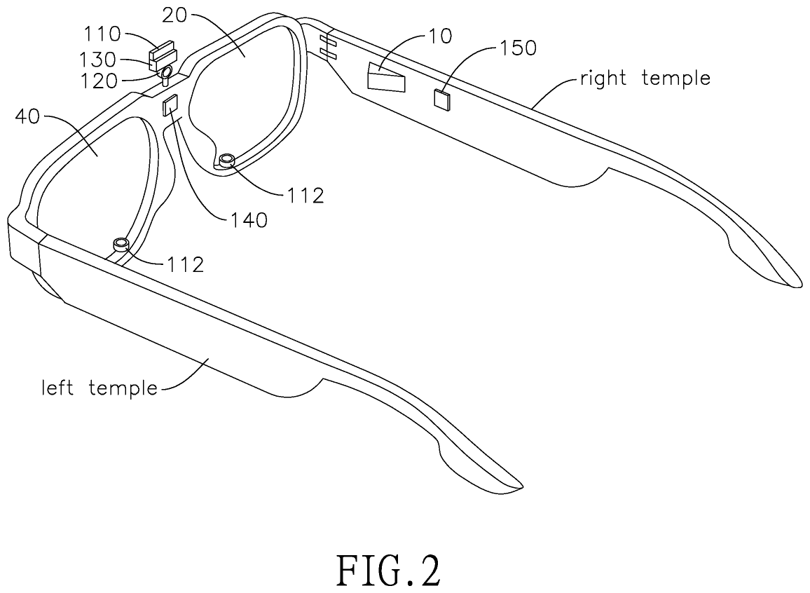

As shown in FIG. 2, the system 100 further includes a support structure that is wearable on a head of the viewer. The target detection module 110, the image capture module 120, the process module 150, and the display module 160 (including a right light signal generator 10, a right combiner 20, a left light signal generator 30, and a left combiner 40) are carried by the support structure. In one embodiment, the system is a head wearable device, such as a virtual reality (VR) goggle and a pair of augmented reality (AR)/mixed reality (MR) glasses. In this circumstance, the support structure may be a frame with or without lenses of the pair of glasses. The lenses may be prescription lenses used to correct nearsightedness, farsightedness, etc. In addition, the depth sensing module 130 and the position module 140 may be also carried by the support structure.

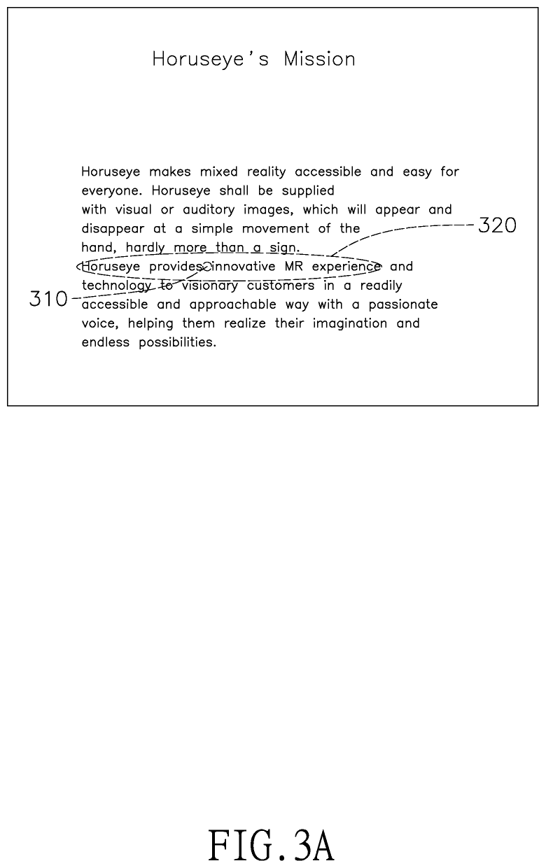

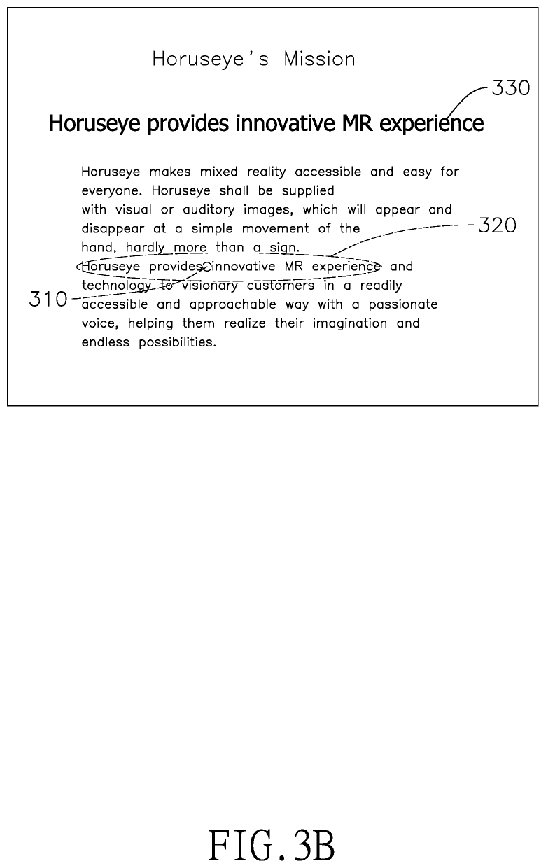

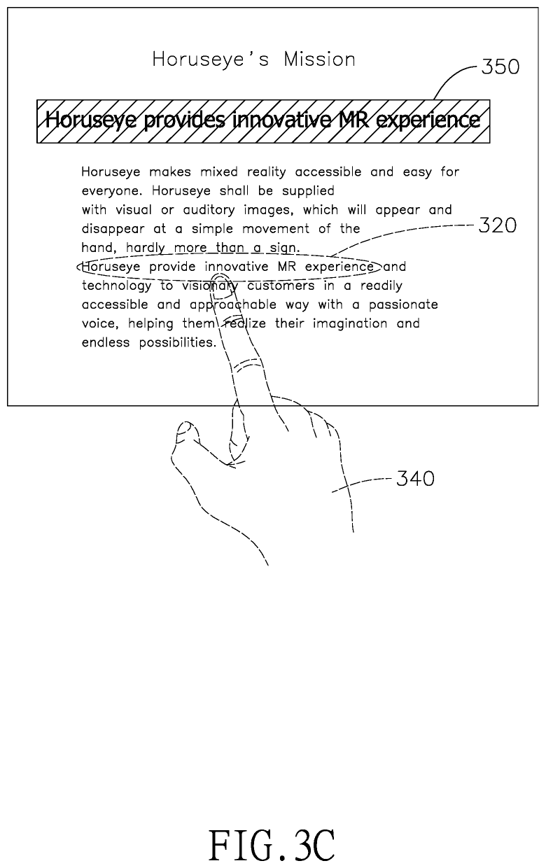

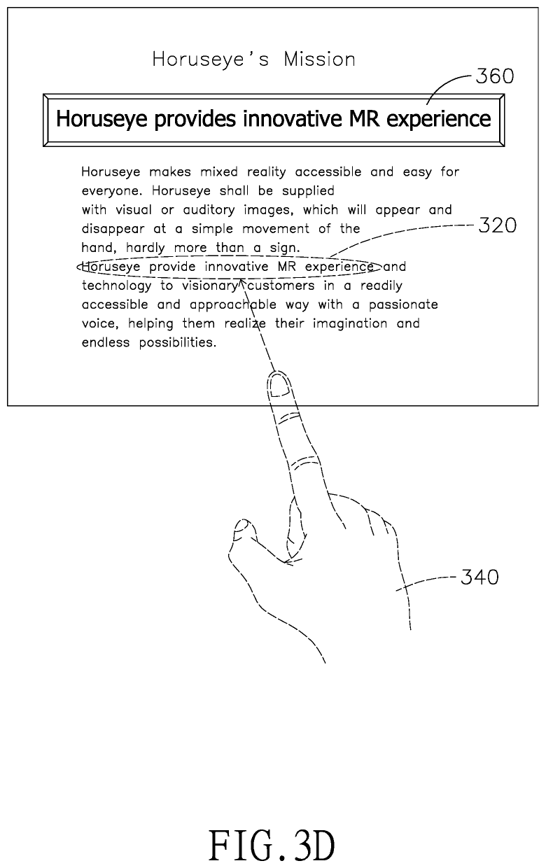

FIGS. 3A-3D illustrate the viewer using the system for dynamic image processing to read a document. As shown in FIG. 3A, the target detection module 110 detects the location and depth the viewer's eyes fixate (dashed circle 310) to determine the target object—words in the dashed circle 320. The image capture module 120 takes a target image of the target object for the process module 150 to process and generate information for the virtual image. As shown in FIG. 3B, the virtual image 330 including the magnified words on the target object is displayed at a blank area of the document at approximately the same depth. As shown in FIG. 3C, the target detection module 110 detects the reader's index finger touches the document at a specific location and determines the target object 320. FIG. 3C also illustrates that the display module 160 displays the virtual image 350 in a reversed black-white format, which is processed by the process module 150. The background and the words may be supplementary colors, such as green and red, yellow and purple, orange and blue, and green and magenta. As shown in FIG. 3D, the target detection module 110 detects the reader's index finger points at a specific location on the document by the gesture recognition unit 114 and determines the target object 320. FIG. 3D also illustrates that the display module 160 displays the virtual image 360 in a 3D format at a depth closer to the viewer.

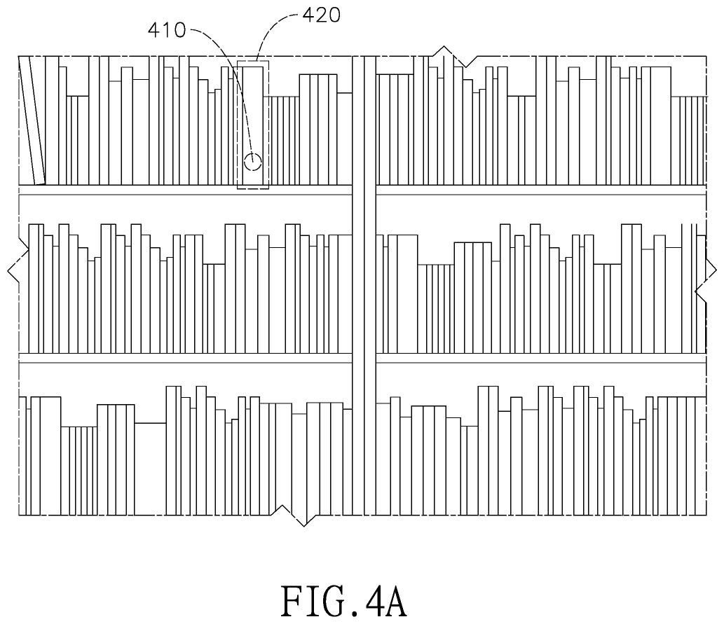

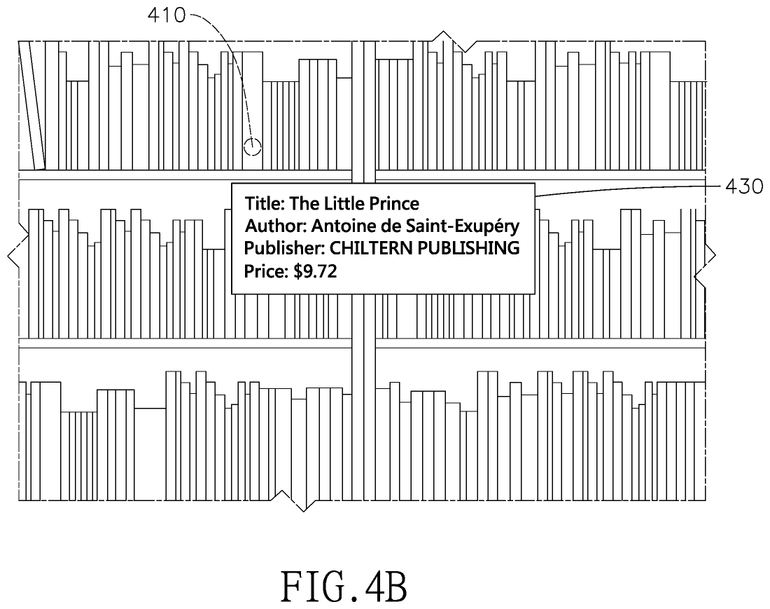

FIGS. 4A-4B illustrate the viewer using the system for dynamic image processing to read a title of a book on a book shelf. As shown in FIG. 4A, the target detection module 110 detects the location and depth the viewer's eyes fixate (dashed circle 410) to determine the target object—title of the book shown in the dashed rectangle 420. The image capture module 120 takes a target image of the target object for the process module 150 to process and generate information for the virtual image. As shown in FIG. 4B, the virtual image 430 including the magnified words to provide information of the book's title, author, publisher, and the price in a predetermined size, color, contrast, and brightness adjacent to the book (the target object) and at approximately the same depth. The system 100 obtains the information about the publisher and the price from internet for the viewer.

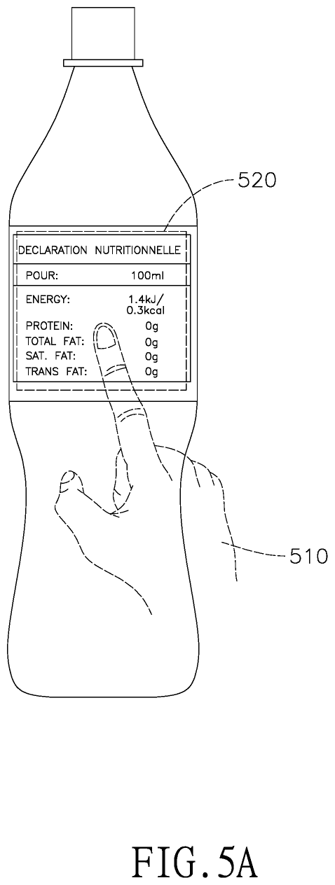

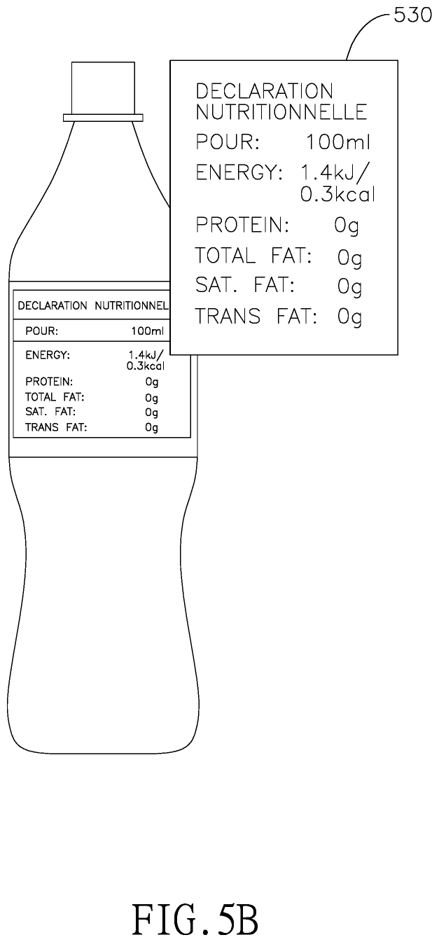

FIGS. 5A-5B illustrate the viewer using the system for dynamic image processing to read an ingredient label of a bottle. Without the assistance of the system 100, the viewer has difficulty in reading the words on such a label because the font size is very small and on a curved bottle surface. As shown in FIG. 5A, the target detection module 110 detects the location and depth the viewer's index finger touches the bottle to determine the target object—ingredient label of the bottle shown in the dashed square 520. The image capture module 120 takes a target image of the target object for the process module 150 to process and generate information for the virtual image. As shown in FIG. 5B, the virtual image 530 including the words on the ingredient label is displayed in a predetermined color, contrast, and brightness, adjacent to the ingredient label of the bottle and at a depth closer to the viewer.

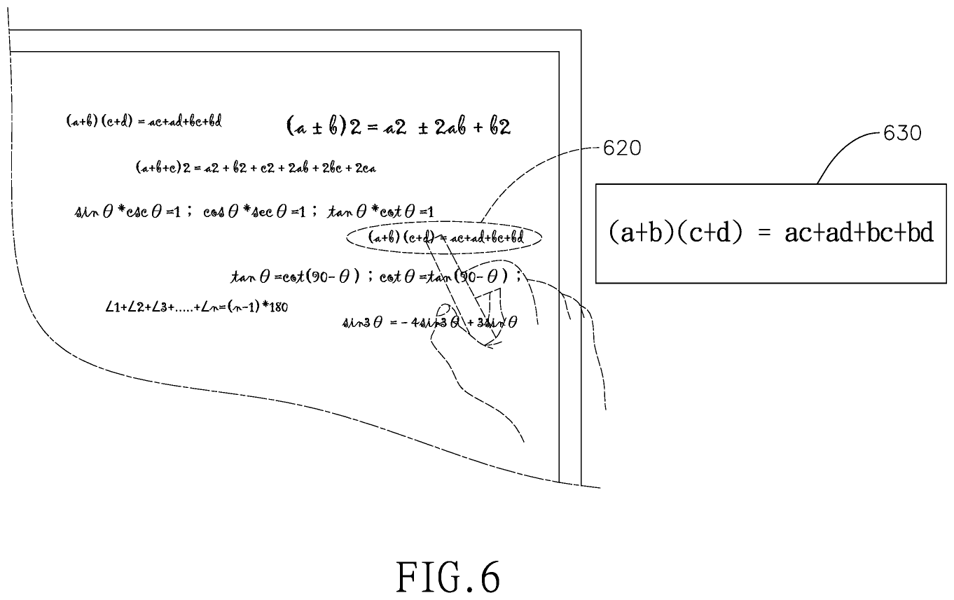

FIG. 6 illustrates the viewer using the system for dynamic image processing to read a hand-written formula on a board. Without the assistance of the system 100, the viewer has difficulty in reading the formula because the handwriting is sloppy and in small size. As shown in FIG. 6, the target detection module 110 detects the location and depth the chalk stick touches the board to determine the target object—the formula shown in the dashed circle 620. The image capture module 120 takes a target image of the target object for the process module 150 to process and generate information for the virtual image. As shown in FIG. 6, the virtual image 630 including the formula is displayed in a predetermined size, color, contrast, and brightness, adjacent to the formula and at a depth approximately the same as the board.

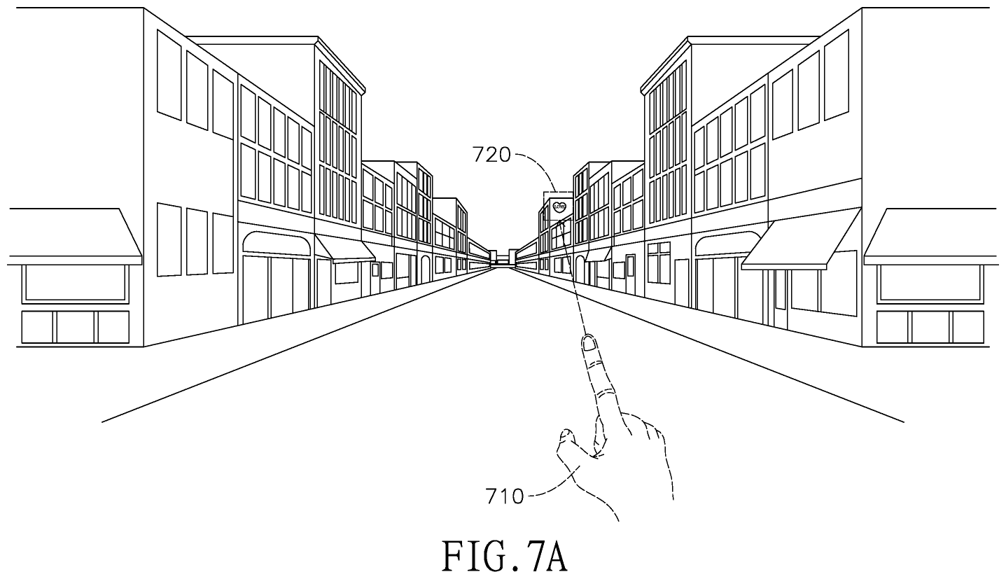

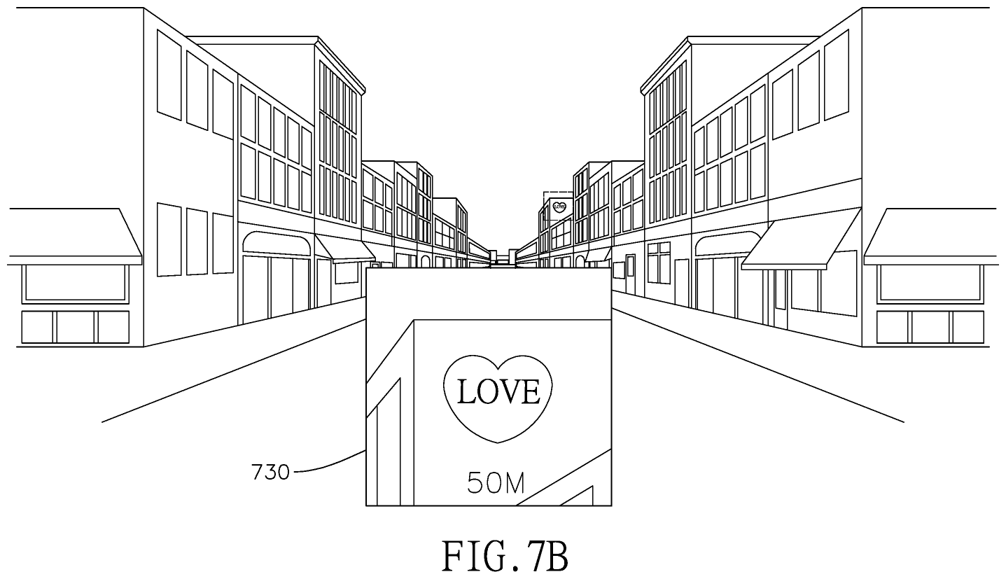

FIGS. 7A-7B illustrate the viewer using the system for dynamic image processing to read a store sign remote away. Without the assistance of the system 100, the viewer has difficulty in reading the sign because the sign is small and far away. As shown in FIG. 7A, the target detection module 110 detects the location and depth the viewer's index finger points to—the store sign shown in the dashed square 720. The image capture module 120 takes a target image of the target object for the process module 150 to process and generate information for the virtual image. As shown in FIG. 7B, the virtual image 730 including the magnified sign is displayed in a predetermined contrast, and brightness at a depth much closer to the viewer. The virtual image also includes the distance between the viewer and the sign, for example 50 m, provided by the depth sensing module 130.

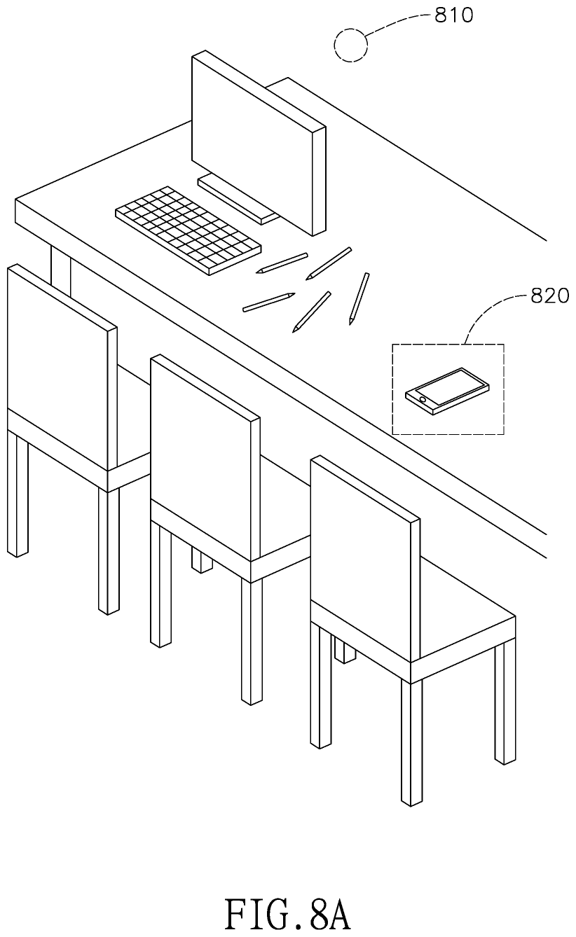

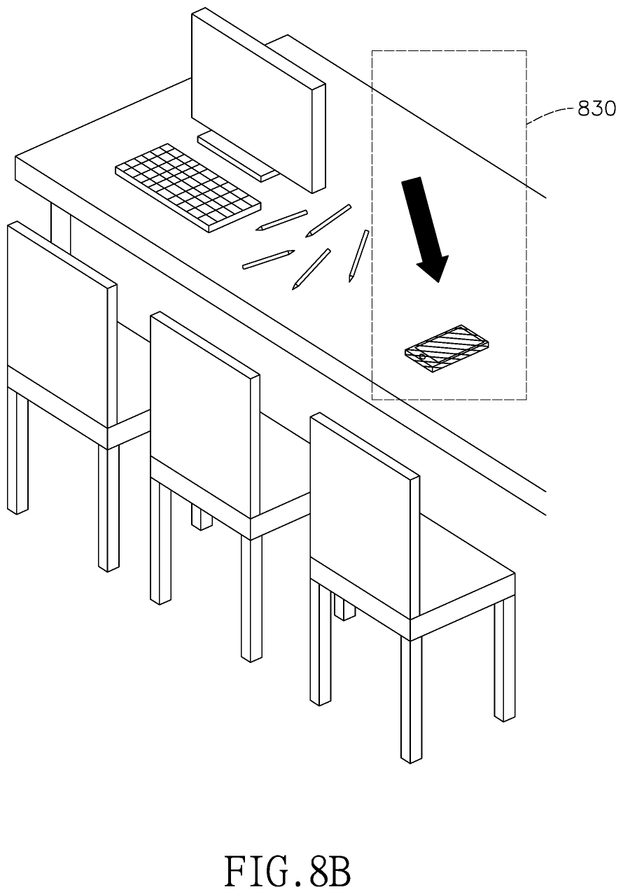

FIGS. 8A-8B illustrate the viewer using the system for dynamic image processing to find his/her mobile phone on a desk. As shown in FIG. 8A, the target detection module 110 detects the viewer's voice by the voice recognition unit 116 to determine the target object—the viewer's mobile phone shown in the dashed square 820. The image capture module 120 scans surroundings to identify and locate the viewer's mobile phone. The process module 150 then process the target image and generate information for the virtual image. As shown in FIG. 8B, the virtual image 830 including the visual surface of the mobile phone is displayed in a predetermined color, contrast, and brightness to superimpose on the mobile phone and at a depth approximately the same as the mobile phone. A bright color is usually used to draw the viewer's attention. Thee virtual image also includes an arrow between the location the viewer's eyes originally fixate and the location of the mobile phone to guide the viewer to locate the mobile phone.

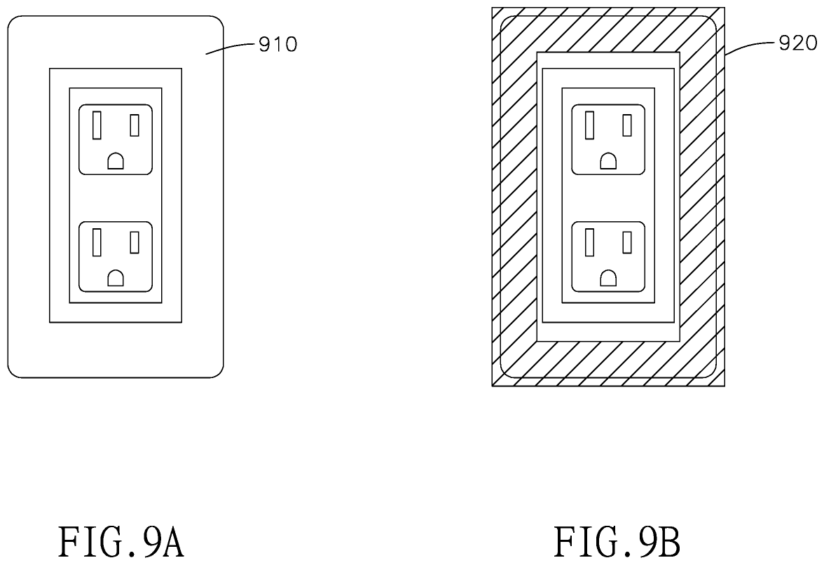

FIGS. 9A-9B illustrate the viewer using the system for dynamic image processing to find an electric outlet. As shown in FIG. 9A, the target detection module 110 detects the viewer's voice by the voice recognition unit 116 to determine the target object—the electric outlet 820. The image capture module 120 scans surroundings to identify and locate the electric outlet. The process module 150 then process the target image and generate information for the virtual image. As shown in FIG. 9B, the virtual image 930 including the contour of the electric outlet is displayed in a predetermined color, contrast, and brightness to superimpose on the electronic outlet and at a depth approximately the same as the mobile phone.

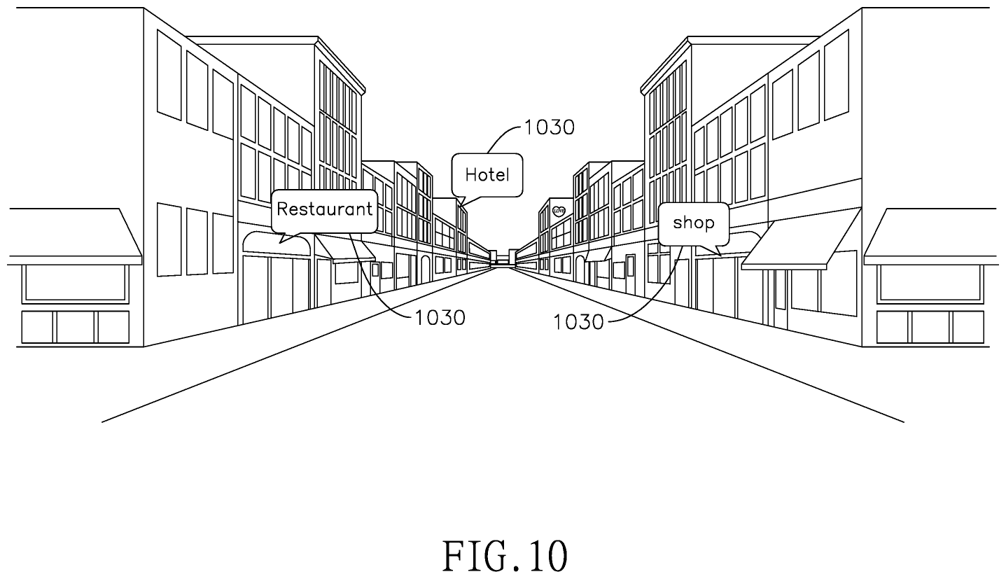

FIG. 10 illustrates the viewer using the system for dynamic image processing to find stores on a street. As shown in FIG. 10, the target detection module 110 detects the viewer's voice by the voice recognition unit 116 to determine the target object—the stores. The system 100 uses the image capture module 120 to scan surroundings and the position module 140 to identify the viewer's location, and then retrieve store information from maps and other resources on internet. The process module 150 then process the target image and generate information for the virtual image. As shown in FIG. 10, the virtual image 1030, including the type of the stores, such as restaurant, hotel, and shop, is displayed in a predetermined color, contrast, and brightness to superimpose on the stores and at a depth approximately the same as the stores.

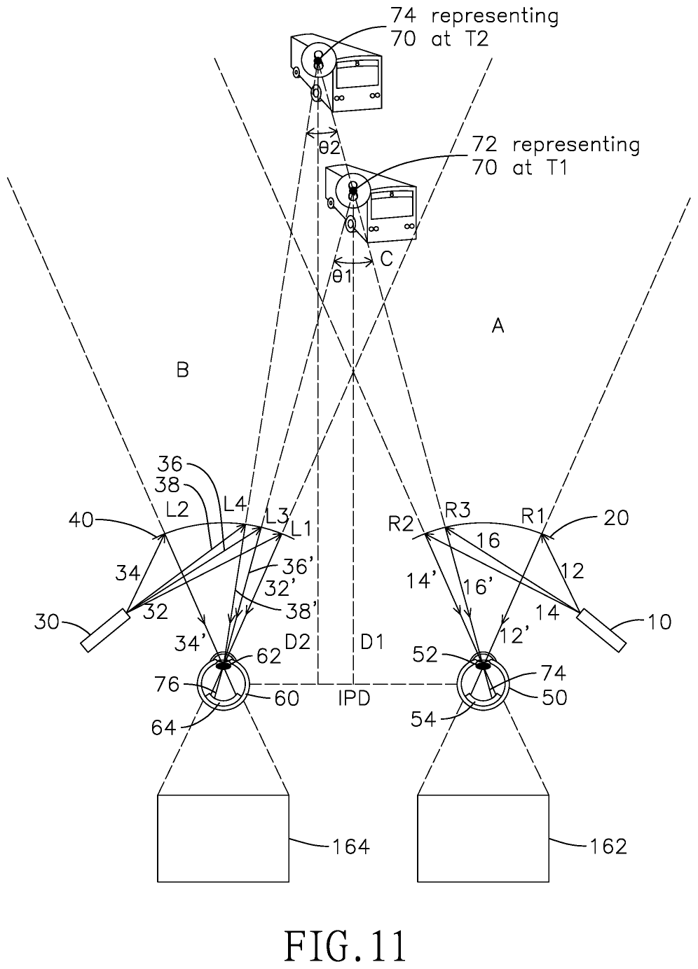

FIG. 11 illustrates the viewer using the system for dynamic image processing to track a bus moving towards a bus stop. The target detection module 110 detects the viewer's voice, by the voice recognition unit 116 to obtain the bus number, for example bus route number 8, to determine the target object—the bus 8. The system may communicate with a transportation control center or retrieve information from internet to obtain a bus schedule or the time the bus 8 is expected to arrive the specific bus stop. The system may display an alert virtual image to inform the viewer that the bus 8 is expected to arrive within a predetermined time period, such as 3 minutes. As a result, the viewer would observe towards the direction that the bus 8 would approach. Then, the system 100 uses the image capture module 120 to scan surroundings to locate and identify the coming bus 8. The process module 150 then process the target image and generate information for the virtual image. As shown in FIG. 11, the virtual image 70, including the number 8 and the circle, is displayed in a predetermined size, color, contrast, and brightness to superimpose on the bus 8 and at a depth approximately the same as the bus 8. In addition, the virtual image 70 remains to superimpose on the bus 8 when the bus 8 is moving from a second position T2 to a first position T1 towards the bus stop. The virtual image 70 at the first position T1 is represented by a pixel 72 and the virtual image 70 at the second position T2 is represented by a pixel 74.

As shown in FIG. 11, the display module 160 is configured to display the virtual image 70, the number 8 within a circle, by projecting multiple right light signals to a viewer's first eye 50 to form a right image 162 and corresponding multiple left light signals to a viewer's second eye 60 to form an left image 164. The virtual image 70 is displayed at a first location and a first depth 72 (collectively the “first position” or “T1”). The display module 160 includes a right light signal generator 10 to generate multiple right light signals such as 12 for NLS_1, 14 for NLS_1 and 16 for NLS_3, a right combiner 20 to redirect the multiple right light signals towards the right retina 54 of a viewer, an left light signal generator 30 to generate multiple left light signals such as 32 for ALS_1, 34 for ALS_2, and 36 for ALS_3, and an left combiner 40 to redirect the multiple left light signals towards an left retina 64 of the viewer. The viewer has a right eye 50 containing a right pupil 52 and a right retina 54, and a left eye 60 containing a left pupil 62 and a left retina 64. The diameter of a human's pupil generally may range from 2 to 8 mm in part depending on the environmental lights. The right pupil size in adults varies from 2 to 4 mm in diameter in bright light and from 4 to 8 mm in dark. The multiple right light signals are redirected by the right combiner 20, pass the right pupil 52, and are eventually received by the right retina 54. The right light signal RLS_1 is the light signal farthest to the right the viewer's right eye can see on a specific horizontal plan. The right light signal RLS_2 is the light signal farthest to the left the viewer's right eye can see on the same horizontal plane. Upon receipt of the redirected right light signals, the viewer would perceive multiple right pixels (forming the right image) for the virtual image 70 at the first position T1 in the area A bounded by the extensions of the redirected right light signals RLS_1 and RLS_2. The area A is referred to as the field of view (FOV) for the right eye 50. Likewise, the multiple left light signals are redirected by the left combiner 40, pass the center of the left pupil 62, and are eventually received by the left retina 64. The left light signal LLS_1 is the light signal farthest to the right the viewer's left eye can see on the specific horizontal plan. The left light signal LLS_2 is the light signal farthest to the left the viewer's left eye can see on the same horizontal plane. Upon receipt of the redirected left light signals, the viewer would perceive multiple left pixels (forming left image) for the virtual image 70 in the area B bounded by the extensions of the redirected left light signals LLS_1 and LLS_2. The area B is referred to as the field of view (FOV) for the left eye 60. When both multiple right pixels and left pixels are displayed in the area C which are overlapped by area A and area B, at least one right light signal displaying one right pixel and a corresponding left light signal displaying one left pixel are fused to display a virtual binocular pixel with a specific depth in the area C. The first depth D1 is related to an angle θ1 of the redirected right light signal 16′ and the redirected left light signal 36′ projected into the viewer's retinas. Such angle is also referred to as a convergence angle.

As described above, the viewer's first eye 50 perceives the right image 162 of the virtual image 70 and the viewer's second eye 60 perceives the left image 164 of the virtual image 70. For a viewer with appropriate image fusion function, he/she would perceive a single virtual image at the first location and the first depth because his/her brain would fuse the right image 162 and the left image 164 into one binocular virtual image. However, if a viewer has a weak eye with impaired vision, he/she may not have appropriate image fusion function. In this situation, the viewer's first eye 50 and the second eye 60 may respectively perceive the right image 162 at a first right image location and depth, and the left image 164 at a first left image location and depth (double vision). The first right image location and depth may be close to but different from the first left image location and depth. In addition, the locations and depths of both the first right image and first left image may be close to the first targeted location and first targeted depth. Again, the first targeted depth D1 is related to the first angel θ1 between the first right light signal 16′ and the corresponding first left light signal 36′ projected into the viewer's eyes.

The display module 160 displays the virtual image 70 moving from the second location and the second depth (collectively the “second position” or “T2”) to the first position T1. The first depth D1 is different from the second depth D2. The second depth D2 is related to a second angle θ2 between the second right light signal 16′ and the corresponding second left light signal 38′.

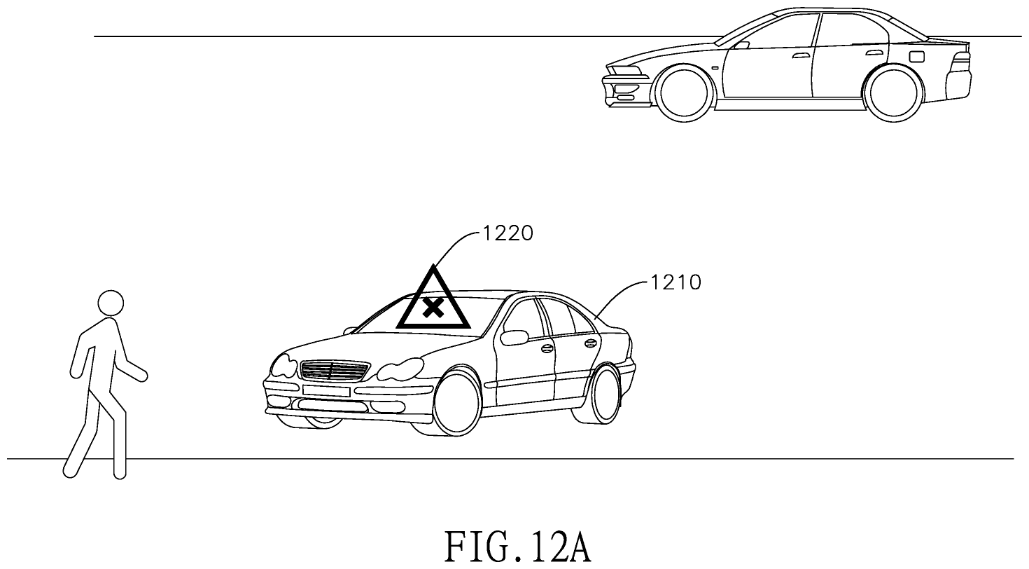

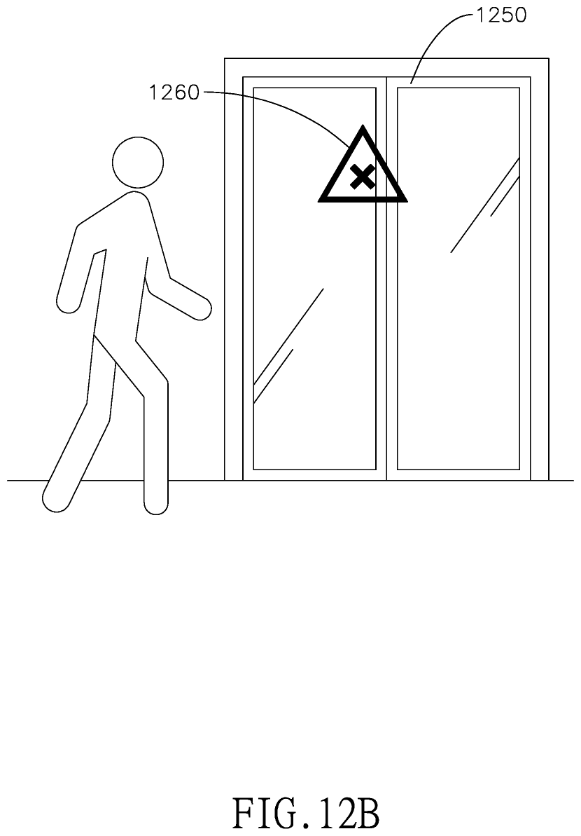

FIGS. 12A-12B illustrate the viewer using the system for dynamic image processing in the collision-free operation mode to avoid collision. As shown in FIG. 12A, the target detection module 110 of the system 100 may use a camera or a lidar to continuously scan surroundings, recognize objects in surroundings, detect how fast the objects move towards the viewer, identify a potential collision object which may collide into the viewer within a predetermined time period, such as 30 seconds, and then determine such potential collision object to be the target object. The process module 150 then process the target image and generate information for the virtual image. As shown in FIG. 12A, to warn the viewer, the virtual image 1210 including a sign is displayed in a predetermined size, color, contrast, and brightness to superimpose on the approaching car and at a depth approximately the same as the approaching car or at a depth closer to the viewer. In addition, the virtual image may remain to be superimposed on the approaching care when the car is moving.

As shown in FIG. 12B, when the viewer walks towards a glass door 1250, the target detection module 110 of the system 100 may use a camera or a lidar to continuously scan surroundings, recognize the glass door and estimate the viewer may collide into the glass door within a predetermined time period, such as 30 seconds, if he or she does not change the direction, and then determine such potential collision object 1250 to be the target object. The process module 150 then process the target image and generate information for the virtual image. As shown in FIG. 12B, to warn the viewer, the virtual image 1260 including a sign is displayed in a predetermined size, color, contrast, and brightness to superimpose on the glass door and at a depth approximately the same as the glass door.

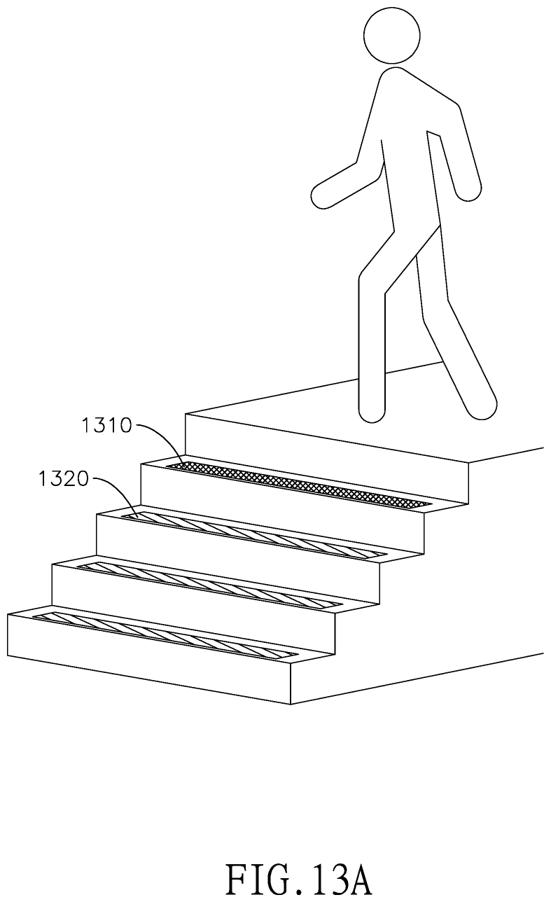

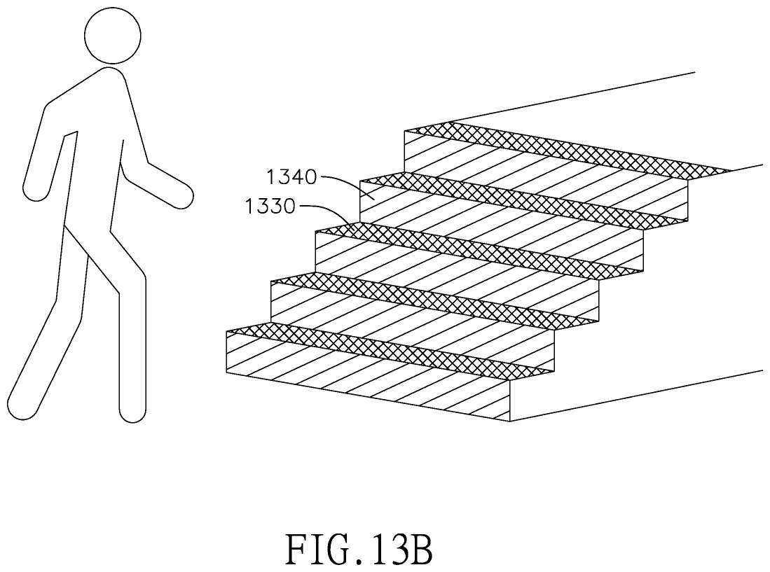

FIGS. 13A-13B illustrate the viewer using the system for dynamic image processing to guide the viewer walking downstairs and upstairs. As shown in FIG. 13A, when the viewer walks toward the stairs going down, the target detection module 110 of the system 100 continuously scan surroundings to detect the uneven ground level to determine the target object—the stairs. The image capture module 120 takes image of the stairs. The process module 150 then process the target image and generate information for the virtual image. As shown in FIG. 13A, to guide the viewer, the virtual image 1310 including the partial surface of the tread portion of the next step is displayed in a predetermined color, contrast, and brightness to superimpose on the tread portion and at a depth approximately the same as the tread portion. The partial surface of the tread portion usually includes the edge so that the viewer notices where he or she can put his/her foot on. The virtual image may include the surface of the tread portion of the remaining steps 1320, which is displayed at a different color. The surface of tread portion of two adjacent steps may look very close to each. To clearly show the viewer which surface is the tread portion of the next step, the virtual image may use a different color to mark it. For example, the tread portion of the next step is marked with green color while the tread portion of the remaining steps are marked with yellow color. Thus, when the viewer walks down the stairs, the tread portion of his next step is always marked with a green color.

As shown in FIG. 13B, when the viewer walks towards the stairs going up, the target detection module 110 detects the uneven ground level to determine the target object—the stairs. The process module 150 then process the target image and generate information for the virtual image. As shown in FIG. 13B, to guide the viewer, the virtual image 1330 including the surface of the tread portion of the steps is displayed in a predetermined color, contrast, and brightness to superimpose on the tread portion and at a depth approximately the same as the tread portion. The virtual image may include the surface of the riser portion of the steps 1340, which is displayed at a different color.

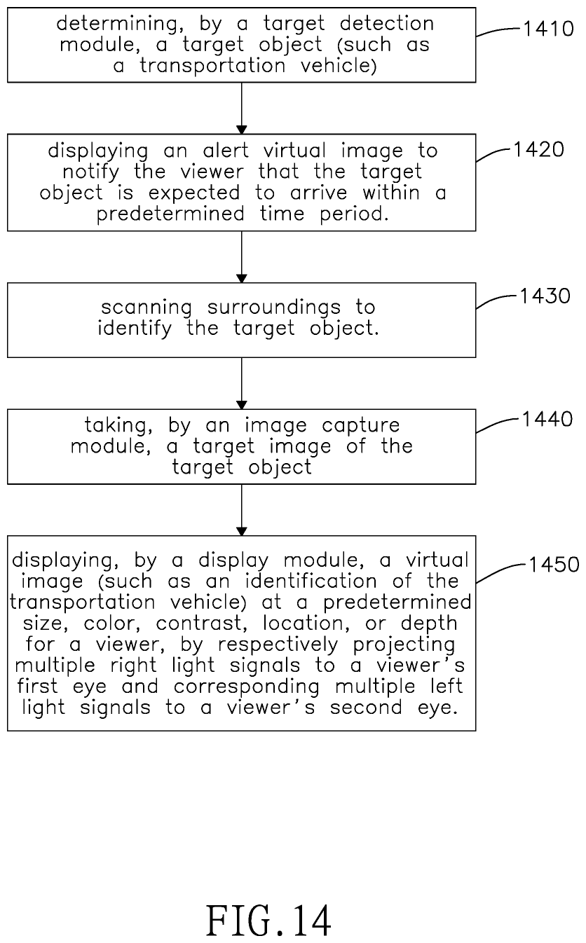

FIG. 14 is a flow chart illustrating an embodiment of processes for tracking a target object in accordance with the present invention. In step 1410, the target detection module determines a target object (such as a transportation vehicle). In step 1420, the display module displays an alert virtual image to notify the viewer that the target object is expected to arrive within a predetermined time period. In step 1430, the system 100 scans surroundings to identify the target object. In step 1440, a target image module takes a target image of the target object. In step 1450, a display module displays a virtual image (such as an identification of the transportation vehicle) at a predetermined size, color, contrast, brightness, location, or depth for a viewer, by respectively projecting multiple right light signals to a viewer's first eye and corresponding multiple left light signals to a viewer's second eye. The virtual image usually is related to the target object but not necessary.

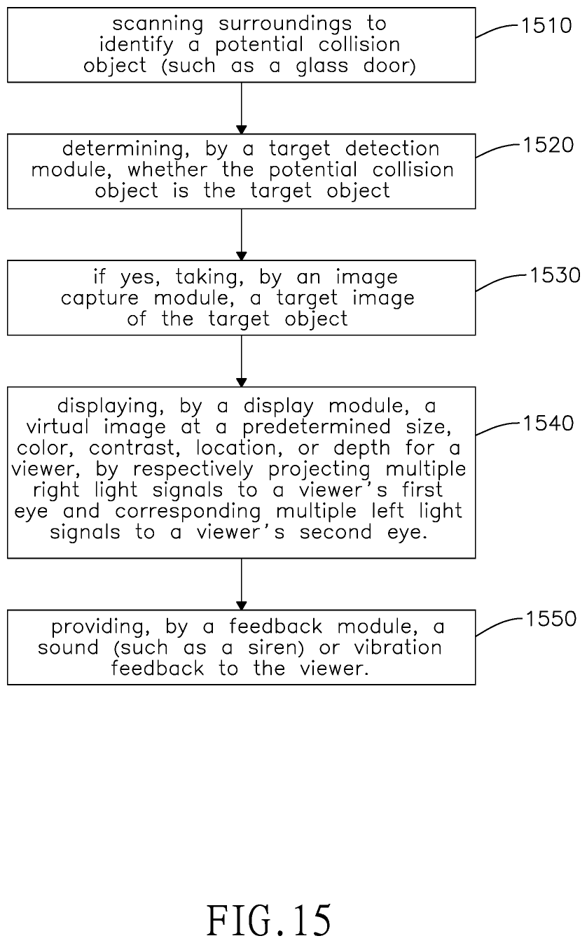

FIG. 15 is a flow chart illustrating an embodiment of processes for scanning surroundings to avoid in accordance with the present invention. In step 1510, the system 100 scans surroundings to identify a potential collision object (such as a glass door). In step 1520, a target object module determines whether the potential collision object is the target object. In step 1530, an image capture module takes a target image of the target object taking, if the potential collision object is the target object. In step 1540, a display module displays a virtual image at a predetermined size, color, contrast, brightness, location, or depth for a viewer, by respectively projecting multiple right light signals to a viewer's first eye and corresponding multiple left light signals to a viewer's second eye. In step 1550, a feedback module providing a sound (such as a siren) or vibration feedback to the viewer. The virtual image usually is related to the target object but not necessary.

The display module 160 and the method of generating virtual images at a predetermined locations and depths as well as the method of moving the virtual images as desired are discussed in details below. The PCT international application PCT/US20/59317, filed on Nov. 6, 2020, titled “SYSTEM AND METHOD FOR DISPLAYING AN OBJECT WITH DEPTHS” is incorporated herein by reference at its entirety.

As shown in FIG. 11, the viewer perceives the virtual image 70, the number 8 and the circle, in the area C in front of the viewer. The virtual image 70 is displayed to superimpose on the bus 8 in the real world. The image of the virtual object 70 displayed at a first position T1 (with depth D1) is represented a first virtual binocular pixel 72 (its center point). And when the virtual image 70 is at second position T2 (with depth D2) a moment earlier, it is represented by the second virtual binocular pixel 74. The first angle between the first redirected right light signal 16′ (the first right light signal) and the corresponding first redirected left light signal (the first left light signal) 36′ is 01. The first depth D1 is related to the first angle θ1. In particular, the first depth of the first virtual binocular pixel of the virtual image 70 can be determined by the first angle θ1 between the light path extensions of the first redirected right light signal and the corresponding first redirected left light signal. As a result, the first depth D1 of the first virtual binocular pixel 72 can be calculated approximately by the following formula:

$$Tan ( \frac{θ}{2} ) = \frac{IPD}{2 D}$$

The distance between the right pupil 52 and the left pupil 62 is interpupillary distance (IPD). Similarly, the second angle between the second redirected right light signal (the second right light signal) 18′ and the corresponding second redirected left light signal (the second left light signal) 38′ is θ2. The second depth D2 is related to the second angle θ2. In particular, the second depth D2 of the second virtual binocular pixel 74 of the virtual object 70 at T2 can be determined approximately by the second angle θ2 between the light path extensions of the second redirected right light signal and the corresponding second redirected left light signal by the same formula. Since the second virtual binocular pixel 74 is perceived by the viewer to be further away from the viewer (i.e. with larger depth) than the first virtual binocular pixel 72, the second angle θ2 is smaller than the first angle θ1.

Furthermore, although the redirected right light signal 16′ for RLS_2 and the corresponding redirected left light signal 36′ for LLS_2 together display a first virtual binocular pixel 72 with the first depth D1. The redirected right light signal 16′ for RLS_2 may present an image of the same or different view angle from the corresponding redirected left light signal 36′ for LLS_2. In other words, although the first angle θ1 determines the depth of the first virtual binocular pixel 72, the redirected right light signal 16′ for RLS_2 may be or may not be a parallax of the corresponding redirected left light signal 36′ for LLS_2. Thus, the intensity of red, blue, and green (RBG) color and/or the brightness of the right light signal and the left light signal may be approximately the same or slightly different, because of the shades, view angle, and so forth, to better present some 3D effects.

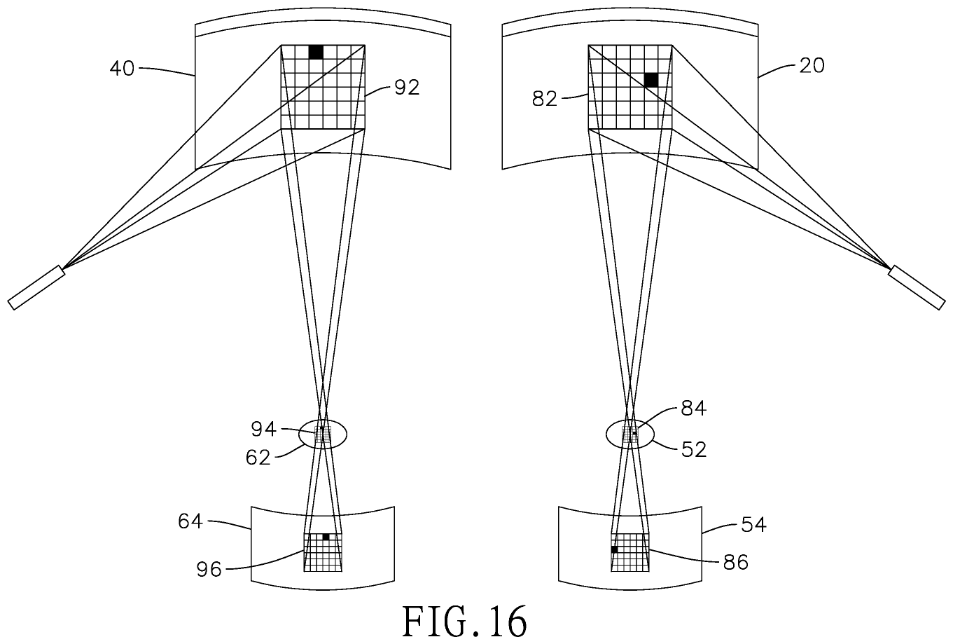

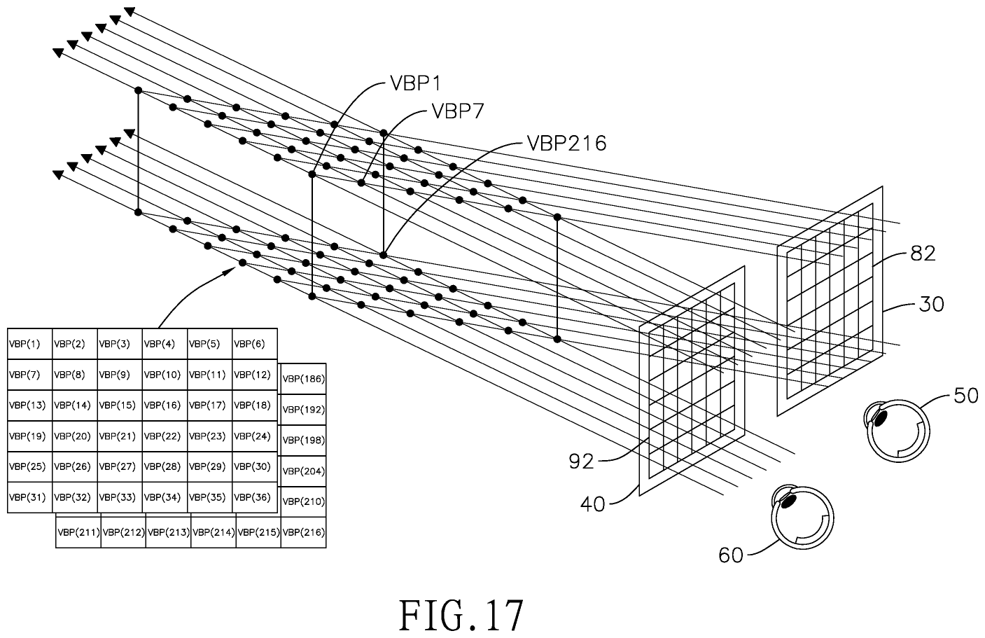

As described above, the multiple right light signals are generated by the right light signal generator 10, redirected by the right combiner 20, and then directly scanned onto the right retina to form a right image 162 (right retina image 86 in FIG. 16) on the right retina. Likewise, the multiple left light signals are generated by left light signal generator 30, redirected by the left combiner 40, and then scanned onto the left retina to form a left image 164 (left retina image 96 in FIG. 16) on the left retina. In an embodiment shown in FIG. 17, a right image 162 contains 36 right pixels in a 6×6 array and a left image 164 also contains 36 left pixels in a 6×6 array. In another embodiment, a right image 162 may contain 921,600 right pixels in a 1280×720 array and an left image 164 may also contain 921,600 left pixels in a 1280×720 array. The display module 160 is configured to generate multiple right light signals and corresponding multiple left light signals which respectively form the right image 162 on the right retina and left image 164 on the left retina. As a result, the viewer perceives a virtual object with specific depths in the area C because of image fusion.

With reference to FIG. 11, the first right light signal 16 from the right light signal generator 10 is received and reflected by the right combiner 20. The first redirected right light signal 16′, through the right pupil 52, arrives the right retina of the viewer to display the right retina pixel R43. The corresponding left light signal 36 from the left light signal generator 30 is received and reflected by the left combiner 40. The first redirected light signal 36′, through the left pupil 62, arrives the left retina of the viewer to display the left retina pixel L33. As a result of image fusion, a viewer perceives the virtual image 70 at the first depth D1 determined by the first angle of the first redirected right light signal and the corresponding first redirected left light signal. The angle between a redirected right light signal and a corresponding left light signal is determined by the relative horizontal distance of the right pixel and the left pixel. Thus, the depth of a virtual binocular pixel is inversely correlated to the relative horizontal distance between the right pixel and the corresponding left pixel forming the virtual binocular pixel. In other words, the deeper a virtual binocular pixel is perceived by the viewer, the smaller the relative horizontal distance at X axis between the right pixel and left pixel forming such a virtual binocular pixel is. For example, as shown in FIG. 11, the second virtual binocular pixel 74 is perceived by the viewer to have a larger depth (i.e. further away from the viewer) than the first virtual binocular pixel 72. Thus, the horizontal distance between the second right pixel and the second left pixel is smaller than the horizontal distance between the first right pixel and the first left pixel on the retina images 162, 164. Specifically, the horizontal distance between the second right pixel R41 and the second left pixel L51 forming the second virtual binocular pixel 74 is four-pixel long. However, the distance between the first right pixel R43 and the first left pixel L33 forming the first virtual binocular pixel 72 is six-pixel long.

In one embodiment shown in FIG. 16, the light paths of multiple right light signals and multiple left light signals from light signal generators to retinas are illustrated. The multiple right light signals generated from the right light signal generator 10 are projected onto the right combiner 20 to form a right combiner image (RSI) 82. These multiple right light signals are redirected by the right combiner 20 and converge into a small right pupil image (RPI) 84 to pass through the right pupil 52, and then eventually arrive the right retina 54 to form a right retina image (RRI) 86 (right image 162). Each of the RSI, RPI, and RRI comprises i×j pixels. Each right light signal RLS(i,j) travels through the same corresponding pixels from RSI(i,j), to RPI(i,j), and then to RRI(x,y). For example RLS(5,3) travels from RSI(5,3), to RPI(5,3) and then to RRI(2,4). Likewise, the multiple left light signals generated from the left light signal generator are projected onto the left combiner 40 to form a left combiner image (LSI) 92. These multiple left light signals are redirected by the left combiner 40 and converge into a small left pupil image (LPI) 94 to pass through the left pupil 62, and then eventually arrive the left retina 64 to form a left retina image (LRI) 96 (left image 124). Each of the LSI, LPI, and LRI comprises i×j pixels. Each left light signal ALS(i,j) travels through the same corresponding pixels from LCI(i,j), to LPI(i,j), and then to LRI(x,y). For example LLS(3,1) travels from LCI(3,1), to LPI(3,1) and then to LRI(4,6). The (0, 0) pixel is the top and left most pixel of each image. Pixels in the retina image is left-right inverted and top-bottom inverted to the corresponding pixels in the combiner image. Based on appropriate arrangements of the relative positions and angles of the light signal generators and combiners, each light signal has its own light path from a light signal generator to a retina. The combination of one right light signal displaying one right pixel on the right retina and one corresponding left light signal displaying one left pixel on the left retina forms a virtual binocular pixel with a specific depth perceived by a viewer. Thus, a virtual binocular pixel in the space can be represented by a pair of right retina pixel and left retina pixel or a pair of right combiner pixel and left combiner pixel.

A virtual object perceived by a viewer in area C may include multiple virtual binocular pixels but is represented by one virtual binocular pixel in this disclosure. To precisely describe the location of a virtual binocular pixel in the space, each location in the space is provided a three dimensional (3D) coordinate, for example XYZ coordinate. Other 3D coordinate system can be used in another embodiment. As a result, each virtual binocular pixel has a 3D coordinate—a horizontal direction, a vertical direction, and a depth direction. A horizontal direction (or X axis direction) is along the direction of interpupillary line. A vertical direction (or Y axis direction) is along the facial midline and perpendicular to the horizontal direction. A depth direction (or Z axis direction) is right to the frontal plane and perpendicular to both the horizontal and vertical directions. The horizontal direction coordinate and vertical direction coordinate are collectively referred to as the location in the present invention.

FIG. 17 illustrates the relationship between pixels in the right combiner image, pixels in the left combiner image, and the virtual binocular pixels. As described above, pixels in the right combiner image are one to one correspondence to pixels in the right retina image (right pixels). Pixels in the left combiner image are one to one correspondence to pixels in the left retina image (left pixels). However, pixels in the retina image is left-right inverted and top-bottom inverted to the corresponding pixels in the combiner image. For a right retina image comprising 36 (6×6) right pixels and a left retina image comprising 36 (6×6) left pixels, there are 216 (6×6×6) virtual binocular pixels (shown as a dot) in the area C assuming all light signals are within FOV of both eyes of the viewer. The light path extension of one redirected right light signal intersects the light path extension of each redirected left light signal on the same row of the image. Likewise, the light path extension of one redirected left light signal intersects the light path extension of each redirected right light signal on the same row of the image. Thus, there are 36 (6×6) virtual binocular pixels on one layer and 6 layers in the space. There is usually a small angle between two adjacent lines representing light path extensions to intersect and form virtual binocular pixels although they are shown as parallel lines in the FIG. 17. A right pixel and a corresponding left pixel at approximately the same height of each retina (i.e. the same row of the right retina image and left retina image) tend to fuse earlier. As a result, right pixels are paired with left pixels at the same row of the retina image to form virtual binocular pixels.

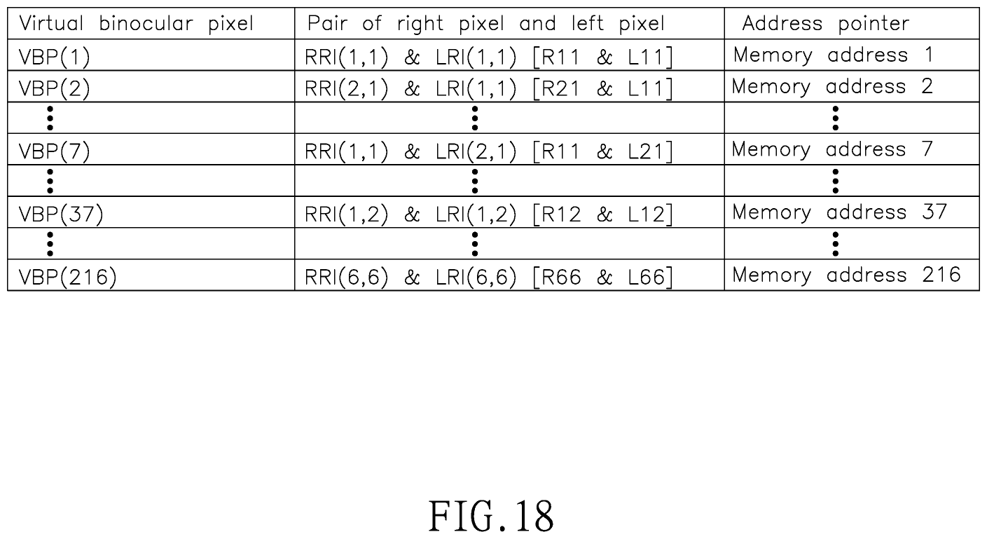

As shown in FIG. 18, a look-up table is created to facilitate identifying the right pixel and left pixel pair for each virtual binocular pixel. For example, 216 virtual binocular pixels, numbering from 1 to 216, are formed by 36 (6×6) right pixels and 36 (6×6) left pixels. The first (1^{st}) virtual binocular pixel VBP(1) represents the pair of right pixel RRI(1,1) and left pixel LRI(1,1). The second (2^{nd}) virtual binocular pixel VBP(2) represents the pair of right pixel RRI(2,1) and left pixel LRI(1,1). The seventh (7th) virtual binocular pixel VBP(7) represents the pair of right pixel RRI(1,1) and left pixel LRI(2,1). The thirty-seventh (37^{th}) virtual binocular pixel VBP(37) represents the pair of right pixel RRI(1,2) and left pixel LRI(1,2). The two hundred and sixteenth (216^{th}) virtual binocular pixel VBP(216) represents the pair of right pixel RRI(6,6) and left pixel LRI(6,6). Thus, in order to display a specific virtual binocular pixel of a virtual object in the space for the viewer, it is determined which pair of the right pixel and left pixel can be used for generating the corresponding right light signal and left light signal. In addition, each row of a virtual binocular pixel on the look-up table includes a pointer which leads to a memory address that stores the perceived depth (z) of the VBP and the perceived position (x,y) of the VBP. Additional information, such as scale of size, number of overlapping objects, and depth in sequence depth etc., can also be stored for the VBP. Scale of size may be the relative size information of a specific VBP compared against a standard VBP. For example, the scale of size may be set to be 1 when the virtual object is displayed at a standard VBP that is 1 m in front of the viewer. As a result, the scale of size may be set to be 1.2 for a specific VBP that is 90 cm in front of the viewer. Likewise, when the scale of size may be set to be 0.8 for a specific VBP that is 1.5 m in front of the viewer. The scale of size can be used to determine the size of the virtual object for displaying when the virtual object is moved from a first depth to a second depth. Scale of size may be the magnification in the present invention. The number of overlapping objects is the number of objects that are overlapped with one another so that one object is completely or partially hidden behind another object. The depth in sequence provides information about sequence of depths of various overlapping images. For example, 3 images overlapping with each other. The depth in sequence of the first image in the front may be set to be 1 and the depth in sequence of the second image hidden behind the first image may be set to be 2. The number of overlapping images and the depth in sequence may be used to determine which and what portion of the images need to be displayed when various overlapping images are in moving.

The look up table may be created by the following processes. At the first step, obtain an individual virtual map based on his/her IPD, created by the virtual image module during initiation or calibration, which specify the boundary of the area C where the viewer can perceive a virtual object with depths because of the fusion of right retina image and left retina image. At the second step, for each depth at Z axis direction (each point at Z-coordinate), calculate the convergence angle to identify the pair of right pixel and left pixel respectively on the right retina image and the left retina image regardless of the X-coordinate and Y-coordinate location. At the third step, move the pair of right pixel and left pixel along X axis direction to identify the X-coordinate and Z-coordinate of each pair of right pixel and left pixel at a specific depth regardless of the Y-coordinate location. At the fourth step, move the pair of right pixel and left pixel along Y axis direction to determine the Y-coordinate of each pair of right pixel and left pixel. As a result, the 3D coordinate system such as XYZ of each pair of right pixel and left pixel respectively on the right retina image and the left retina image can be determined to create the look up table. In addition, the third step and the fourth step are exchangeable.

The light signal generator 10 and 30 may use laser, light emitting diode (“LED”) including mini and micro LED, organic light emitting diode (“OLED”), or superluminescent diode (“SLD”), LCoS (Liquid Crystal on Silicon), liquid crystal display (“LCD”), or any combination thereof as its light source. In one embodiment, the light signal generator 10 and 30 is a laser beam scanning projector (LBS projector) which may comprise the light source including a red color light laser, a green color light laser, and a blue color light laser, a light color modifier, such as Dichroic combiner and Polarizing combiner, and a two dimensional (2D) adjustable reflector, such as a 2D electromechanical system (“MEMS”) mirror. The 2D adjustable reflector can be replaced by two one dimensional (1D) reflector, such as two 1D MEMS mirror. The LBS projector sequentially generates and scans light signals one by one to form a 2D image at a predetermined resolution, for example 1280×720 pixels per frame. Thus, one light signal for one pixel is generated and projected at a time towards the combiner 20, 40. For a viewer to see such a 2D image from one eye, the LBS projector has to sequentially generate light signals for each pixel, for example 1280×720 light signals, within the time period of persistence of vision, for example 1/18 second. Thus, the time duration of each light signal is about 60.28 nanosecond.

In another embodiment, the light signal generator 10 and 30 may be a digital light processing projector (“DLP projector”) which can generate a 2D color image at one time. Texas Instrument's DLP technology is one of several technologies that can be used to manufacture the DLP projector. The whole 2D color image frame, which for example may comprise 1280×720 pixels, is simultaneously projected towards the combiners 20, 40.

The combiner 20, 40 receives and redirects multiple light signals generated by the light signal generator 10, 30. In one embodiment, the combiner 20, 40 reflects the multiple light signals so that the redirected light signals are on the same side of the combiner 20, 40 as the incident light signals. In another embodiment, the combiner 20, 40 refracts the multiple light signals so that the redirected light signals are on the different side of the combiner 20, 40 from the incident light signals. When the combiner 20, 40 functions as a refractor. The reflection ratio can vary widely, such as 20%-80%, in part depending on the power of the light signal generator. People with ordinary skill in the art know how to determine the appropriate reflection ratio based on characteristics of the light signal generators and the combiners. Besides, in one embodiment, the combiner 20, 40 is optically transparent to the ambient (environmental) lights from the opposite side of the incident light signals so that the viewer can observe the real-time image at the same time. The degree of transparency can vary widely depending on the application. For AR/MR application, the transparency is preferred to be more than 50%, such as about 75% in one embodiment.

The combiner 20, 40 may be made of glasses or plastic materials like lens, coated with certain materials such as metals to make it partially transparent and partially reflective. One advantage of using a reflective combiner instead of a wave guide in the prior art for directing light signals to the viewer's eyes is to eliminate the problem of undesirable diffraction effects, such as multiple shadows, color displacement . . . etc.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded the widest scope consistent with the principles and novel features disclosed herein. It is contemplated that additional embodiments are within the spirit and true scope of the disclosed subject matter. Thus, it is intended that the present invention covers modifications and variations that come within the scope of the appended claims and their equivalents.

What is claimed is:

1. A system for dynamic image processing, comprising:
a target detection module configured to determine a target object for a viewer;
an image capture module configured to take a target image of the target object;
a process module to receive the target image, process the target image based on a predetermined process mode, and provide information of a virtual image related to the target image to a display module;
the display module configured to display the virtual image by respectively projecting multiple right light signals to a viewer's first eye and corresponding multiple left light signals to a viewer's second eye; and
wherein a first right light signal and a corresponding first left light signal are perceived by the viewer to display a first virtual binocular pixel of the virtual image with a first depth that is related to a first angle between the first right light signal and the corresponding first left light signal projected into the viewer's eyes.

2. The system of claim 1, wherein the target detection module, comprising an eye tracking unit, determines the target object by tracking eyes of the viewer.

3. The system of claim 1, wherein the target detection module, comprising a gesture recognition unit, determines the target object by detecting a gesture of the viewer.

4. The system of claim 1, wherein the target detection module, comprising a voice recognition unit, determines the target object by detecting a voice of the viewer.

5. The system of claim 1, wherein the target detection module, determines the target object by detecting a potential collision object in surroundings.

6. The system of claim 1, further comprising a depth sensing module to detect depths of the target object.

7. The system of claim 1, further comprising a position module to determine a position and a facing direction of the viewer.

8. The system of claim 1, wherein the display module is calibrated for the viewer so that the virtual image is displayed at a predetermined size, color, contrast, brightness, location, or depth.

9. The system of claim 8, wherein the predetermined size, color, contrast, brightness, location, or depth is related to color or light intensity of surrounding environment.

10. The system of claim 1, wherein the virtual image is displayed at approximately the same depth as the target object.

11. The system of claim 1, wherein the virtual image is displayed to superimpose on the target object.

12. The system of claim 1, wherein the virtual image includes a mark to indicate a relationship with the target object.

13. The system of claim 1, wherein the virtual image contains text language recognized from the target image and is displayed at a larger size or a higher contrast than in the target image.

14. The system of claim 13, wherein the virtual image is displayed at a location adjacent to the target object and at a depth approximately the same as the target object.

15. The system of claim 1, wherein the virtual image contains geometric features recognized from the target image and is displayed to highlight the target object.

16. The system of claim 15, wherein the virtual image is displayed at approximately the same depth as the target object and to superimpose on the target object.

17. The system of claim 15, wherein the virtual image contains a point, a line, an edge, a curve, a corner, a contour, or a surface of the target object.

18. The system of claim 1, the target object in the target image is recognized and the virtual image containing information related to the target object but not contained in the target image is displayed.

19. The system of claim 1, wherein the target detection module, comprising a voice recognition unit, determines the target object by detecting a voice of the viewer, the image capture module scans surroundings to locate the target object, and the display module displays a virtual image superimposed on the target object.

20. The system of claim 1, further comprising:
a depth sensing module, after the image capture module scans surroundings, to continuously detect depths of objects in the surroundings;
a position module to determine a position and a facing direction of the viewer;
wherein the target detection module, after receiving depths of objects in surroundings from the depth sensing module and the position and the facing direction of the viewer from the position module, determines a potential collision object in surroundings as the target object, and a virtual image is displayed to superimpose on the target object and at approximately the same depth as the target object.

21. The system of claim 20, wherein the virtual image contains complimentary colors that continuously flash.

22. The system of claim 1, wherein the target object is a transportation vehicle, the target detection module determines an identification of the target object, the image capture module scans surroundings to locate the target object with the identification, and the virtual image is displayed to be superimposed on the target object.

23. The system of claim 22, wherein the transportation vehicle is a bus and the virtual image includes the identification of the bus.

24. The system of claim 22, wherein the virtual image remains to be superimposed on the target object while the target object is moving.

25. The system of claim 22, wherein after the target detection module determines the identification of the target object, the display module displays an alert virtual image at a predetermined period of time before the target object is expected to arrive.

26. The system of claim 1, wherein the target object is a stair comprising at least one step, and the virtual image including a tread edge of next step is displayed to be superimposed on the target object and at approximately the same depth as the target object.

27. The system of claim 26, wherein when the virtual image includes a tread edge of two or more steps, the tread edge of the next step is displayed at a different color from the tread edge of other steps.

28. The system of claim 26, wherein when the virtual image includes a tread portion and a riser portion of a step, the tread portion is displayed at a different color from the riser portion.

29. The system of claim 1, further comprising:
a feedback module configured to provide a feedback to the viewer when a predetermined condition is satisfied.

30. The system of claim 29, wherein the feedback includes a sound or a vibration.

31. The system of claim 1, further comprising:
an interface module configured for the viewer to communicate with the target detection module, the image capture module, or the display module.

32. The system of claim 1, wherein the display module further comprises
a right light signal generator generating the multiple right light signals to form a right image;
a right combiner redirecting the multiple right light signals towards a retina of a viewer's first eye;
a left signal generator generating the multiple left light signals to form a left image; and
a left combiner redirecting the multiple left light signals towards a retina of a viewer's second eye.

33. The system of claim 1, further comprising:
a support structure wearable on a head of the viewer;
wherein the target detection module, the image capture module, and the display module are carried by the support structure.

34. A method for dynamic image processing a target image of a target object, comprising:
determining, by a target detection module, a target object;
taking, by an image capture module, a target image of the target object;
displaying, by a display module, a virtual image at a predetermined size, color, contrast, brightness, location, or depth for a viewer, by respectively projecting multiple right light signals to a viewer's first eye and corresponding multiple left light signals to a viewer's second eye.

35. The method of claim 34, wherein a first right light signal and a corresponding first left light signal are perceived by the viewer to display a first virtual binocular pixel of the virtual image with a first depth that is related to a first angle between the first right light signal and the corresponding first left light signal projected into the viewer's eyes.

36. The method of claim 34, wherein the target detection module determines the target object by tracking eyes of the viewer, detecting a gesture of the viewer, detecting a voice of the viewer or detecting a potential collision object in surroundings.

37. The method of claim 34, further comprising:
after the target object is determined, displaying an alert virtual image to notify the viewer that the target object is expected to arrive within a predetermined time period.

38. The method of claim 34, further comprising:
after the target object is determined, scanning surroundings to identify the target object.

39. The method of claim 34, wherein the virtual image remains to superimpose on the target object when the target object moves.

40. A method for dynamic image processing a target image of a target object, comprising:
scanning surroundings to identify a potential collision object;
determining, by a target detection module, whether the potential collision object is the target object;
taking, by an image capture module, a target image of the target object, if the potential collision object is the target object; and
displaying, by a display module, a virtual image at a predetermined size, color, contrast, brightness, location, or depth for a viewer, by respectively projecting multiple right light signals to a viewer's first eye and corresponding multiple left light signals to a viewer's second eye.

41. The method of claim 40, further comprising:
providing, by a feedback module, a sound or vibration feedback to the viewer.
